(19) United States
(12) Patent Application Publication
(10) Pub. No.: US 2015/0127254 A1
(43) Pub. Date: May 7, 2015

(54) APPARATUS AND METHOD FOR PROVIDING SEARCH SERVICE

(71) Applicant: NAVER Corporation, Seongnam-Si (KR)

(72) Inventors: Hye Eun NOH, Seongnam-si (KR); Ji Eun PARK, Seongnam-si (KR); Chan Il KIM, Seongnam-si (KR); Kyoung Jin KIM, Seongnam-si (KR)

(21) Appl. No.: 14/533,830

(22) Filed: Nov. 5, 2014

(30) Foreign Application Priority Data
Nov. 6, 2013 (KR) 10-2013-0134378
Jan. 17, 2014 (KR) 10-2014-0006171

(51) Int. Cl. G01C 21/36

(52) U.S. Cl. CPC G01C 21/367
USPC 701/532

(57) ABSTRACT

Systems and methods for providing a search service are provided. A search service providing apparatus includes a search word obtaining unit for receiving a search word from an input device of a user terminal; a search result obtaining unit for obtaining a place search result corresponding to the search word; and a display controller for displaying on a display unit of the user terminal a map for displaying a first point corresponding to a certain location and a second point corresponding to a location of the place search result. The display controller includes a scale determination unit for determining a scale of the map for simultaneously displaying the first and second points on the display unit. The first and second points are displayed on the map of the determined scale.

### RELATED APPLICATION

This application claims the benefit of Korean Patent Application No. 10-2013-0134378 filed on Nov. 6, 2013, the disclosure of which is incorporated herein in its entirety by reference, and Korean Patent Application No. 10-2014-0006171 filed on Jan. 17, 2014, in the Korean Intellectual Property Office, the disclosure of which is incorporated herein in its entirety by reference.

### BACKGROUND

1. Field

One or more embodiments relate to an apparatus and method for providing a search service.

2. Description of the Related Art

As electronic communication technology has advanced, users can use various functions using portable and/or mobile terminals. Portable terminals are very useful since users can freely install various applications therein or delete various applications therefrom and access the Internet via a wireless internet connection.

Portable terminals with a location receiver (e.g., a global positioning system (GPS) receiver) are capable of detecting the current location thereof and have thus contributed to active development and use of location-based services such as an application program related to maps.

Information disclosed in this Background section was already known to the inventor(s) of the inventive concept before achieving the inventive concept and/or is technical information acquired in the process of achieving the inventive concept. Therefore, it may contain information that does not form the prior art that is already known to a person of ordinary skill in the art.

### SUMMARY

At least one example embodiment relates to an apparatus for providing a search service.

According to an example embodiment, an apparatus for providing a search service includes a processor and a display controller. The processor includes a search word obtaining unit configured to receive a search word, and a search result obtaining unit configured to obtain a place search result corresponding to the search word, the place search result indicating a position associated with the search result. The display controller is configured to display on a display device a map for displaying a first point corresponding to a desired position and a second point corresponding to the position indicated by the place search result The display controller includes a scale determination unit configured to determine a scale of the map for displaying the first point and the second point on the map, and simultaneously display the first point and the second point on the display device, and the first point and the second point are displayed on the map according to the determined scale.

One or more example embodiments provide that the first point indicates at least one or a current position of a user, a position selected by the user, and at least one position registered with a bookmark menu, and a first marker is used to indicate the first point on the map, and a second marker is used to identify the second point on the map.

One or more example embodiments provide that the processor further comprises a location selection unit configured to receive position-related information regarding at least one of the positions registered with the bookmark menu, and the first point corresponds to the selected position.

One or more example embodiments provide that the search result obtaining unit is configured to obtain a plurality of search results corresponding to the search word, and the place search result is one of the plurality of search results that is most relevant to the search word from among the plurality of search results.

One or more example embodiments provide that the scale determination unit is further configured to determine, as the scale of the map, a scale for displaying a region on a screen on the display device the region including a first diagonal vertex that corresponds to the first point and a second diagonal vertex that correspond to the second point, the region having a shape that corresponds to a shape of the display device.

One or more example embodiments provide that a preset scale range includes preset upper limit and a preset lower limit.

One or more example embodiments provide that the scale determination unit is further configured to determine a size of the display device and a resolution of the display device, and set the preset scale range based on at least one of the size of the display device and the resolution of the display device.

One or more example embodiments provide that the display controller further comprises a scale comparison unit configured to determine whether the determined scale is within a preset scale range. When the scale comparison unit determines that the determined scale is within the preset scale range, the display controller is configured to display a map including the first point and the second point. When the scale comparison unit determines that the determined scale is not within the preset scale range, the display controller is configured to one of (i) display the map including the second point, and (ii) sequentially provide a first screen displaying the map including the first point in a first scale, a second screen displaying the map including the first point and the second point in a second scale, and a third screen displaying the map including the second point in a third scale.

One or more example embodiments provide that the display controller is configured to display a first animation of changing the map from the first scale to the second scale during a first transition from the first screen to the second screen when the first screen is displayed, and display a second animation of changing the map from the second scale to the third scale during a second transition from the second screen to the third screen when the second screen is displayed.

One or more example embodiments provide that the second scale is less than the first scale and the third scale, and the first animation is a zoom-out animation, and the second animation is a zoom-in animation.

One or more example embodiments provide that the display controller is configured to display on of the first point and the second point at a center of the map in the first screen and the third screen.

One or more example embodiments provide that an orientation of the first point relative to the second point in the second screen is the same as an orientation of a top end of the second screen, and the display controller is configured to display a rotation animation of rotating the map during a transition from the first screen to the second screen when the first screen is displayed.

One or more example embodiments provide that the search result obtaining unit is configured to obtain the search result from a service providing server in which a list of main places is registered, obtain, from the service providing server, information associated with the search result indicating whether the search result corresponds to one of the listed main places and a desired scale for displaying the corresponding one of the listed main places, and when the search result corresponds to the one of the listed the main places, the display controller is configured to display only the second point on a map using one of a basic scale or the desired scale.

One or more example embodiments provide that the search result obtaining unit is configured to obtain information regarding a route corresponding to the search word, and the first point and the second point are correspond to a first junction in the route and a second junction in the route, respectively.

One or more example embodiments provide that the first point and the second point are at least one of consecutive junctions in the route and junctions selected by a user.

One or more example embodiments provide that the display apparatus is configured to display a midpoint between the first point and the second point at a center of the map.

At least one example embodiment relates to a method of providing a search service.

According to an example embodiment, a method of providing a search service using a processor includes receiving, by the processor, a search word from an input device; obtaining, by the processor, a place search result corresponding to the search word; determining, by the processor, a scale of a map for simultaneously displaying a first point corresponding to a desired position and a second point corresponding to a position associated with the place search result; and displaying, by the processor, the first point and the second point on a map having the determined scale.

One or more example embodiments provide that the method further includes determining whether the determined scale is within a preset scale range; when the determined scale is determined to be within the preset scale range displaying a map including the first point and the second point; and when the determined scale is determined to not be within the preset scale range one of (i) displaying the map including the second point, and (ii) sequentially providing a first screen displaying the map including the first point in a first scale, a second screen displaying the map including the first point and the second point in a second scale, and a third screen displaying the map including the second point in a third scale.

One or more example embodiments provide that the method further includes displaying a first animation of changing the map from the first scale to the second scale during a first transition from the first screen to the second screen when the first screen is displayed; and displaying a second animation of changing the map from the second scale to the third scale during a second transition from the second screen to the third screen when the second screen is displayed.

At least one example embodiment relates to a method of providing a search service.

According to an example embodiment, a method of providing a search service using a processor includes obtaining, by the processor, a plurality of place search results; receiving, by the processor, information regarding a position associated with a selected place search result from the plurality of place search result; determining, by the processor, whether a first point and a second point should be displayed on a map in a first scale, the first point corresponding to the selected position and the second point corresponding to one of the plurality of place search results that is closer the selected position than other ones of the plurality of search results; when the determining determines that the first point and the second point should be displayed on the map in the first scale, displaying, by the processor, a map including the first point and the second point on the map in the first scale; and when the determining determines that the first point and the second point should not be displayed on the map in the first scale, displaying, by the processor, the map including only the first point in the first scale, displaying, by the processor, the map including the first point and the second point in a second scale, and displaying, by the processor, the map including only the second point in a third scale.

Further aspects, features, advantages of the inventive concept will be apparent from the drawings, claims, and detailed description of the inventive concept set forth herein.

Such general and detailed aspects of the inventive concept may be implemented using a system, a method, a computer program, or a combination of a system, a method, and a computer program.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating a structure of a search service providing system according to an example embodiment;

FIG. 2 is a block diagram of a structure of a search service providing apparatus included in a user terminal of FIG. 1 according to an example embodiment;

FIG. 3 illustrates results of comparing scales according to an example embodiment;

FIG. 4 is a flowchart of a method of providing a search service according to example an example embodiment;

FIGS. 5 to 8 illustrate various example embodiments in which screens are provided by a search service providing system;

FIG. 9 is illustrates a map service screen according to an example embodiment;

FIG. 10 is a diagram illustrating a screen provided from a search service providing system and displayed on a user terminal according to another example embodiment;

FIG. 11 illustrates a map transition interface representing a transition state according to an example embodiment;

FIG. 12 is a diagram illustrating a case in which a direction of a map changes based on a route according to an example embodiment;

FIG. 13 illustrates a map displaying a transition state according to an example embodiment; and

FIG. 14 is a flowchart of a method of providing a map transition interface according to an example embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Example embodiments disclosed herein may, however, be embodied in many different forms and should not be construed as limited to the example embodiments set forth herein. Rather, these example embodiments are provided so that this disclosure is thorough, and will fully convey the scope of the invention to those skilled in the art. In the drawings, the size and relative sizes of layers and areas may be exaggerated for clarity. Like reference numerals in the drawings denote like elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

As used herein, expressions such as “at least one of,” when preceding a list of elements, modify the entire list of elements and do not modify the individual elements of the list.

It will be understood that although the terms “first,” “second,” etc. may be used herein to describe various components, these components should not be limited by these terms. These components are only used to distinguish one component from another.

As used herein, the singular forms “a,” “an” and “the” are intended to include the plural forms as well, unless the context clearly indicates otherwise.

It will be further understood that the terms “comprise” and/or “comprising” used herein specify the presence of stated features or components, but do not preclude the presence or addition of one or more other features or components.

Sizes of elements in the drawings may be exaggerated for convenience of explanation. In other words, since sizes and thicknesses of components in the drawings are arbitrarily illustrated for convenience of explanation, the following embodiments are not limited thereto. Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of areas illustrated herein but are to include deviations in shapes that result, for example, from manufacturing. For example, an implanted area illustrated as a rectangle will, typically, have rounded or curved features and/or a gradient of implant concentration at its edges rather than a binary change from implanted to non-implanted area. Likewise, a buried area formed by implantation may result in some implantation in the area between the buried area and the surface through which the implantation takes place. Thus, the areas illustrated in the figures are schematic in nature and their shapes are not intended to illustrate the actual shape of an area of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In the following disclosure, the term “location”, “position”, “point”, and the like, may mean a certain place in a space, and a certain point corresponding to the certain location may be present on a map. Herein, the terms “location”, “position”, and “point” may be used interchangeably with each other. In the following disclosure, the term “orientation” and the like, may be indicative of an object's placement within a coordinate system with respect to a fixed, location, position, and/or point and a reference location, position, and/or point.

In the following disclosure, a “gesture” may include any action made by a user on a touchscreen device, such as scrolling, tapping, double tapping, long press, pinch open, pinch close, panning flicking, dragging, rotate, two-finger tapping, two-finger-scrolling, and/or other like touch signals. Additionally, a gesture may include a gesture related criterion, such as holding a gesture for a desired period of time, performing a gesture in a desired position and/or in a desired direction, performing a combination of gestures in a desired sequence, performing a gesture before or after a desired condition is met, and/or other like gesture related criteria. A “flick gesture” may be understood as a sliding gesture performed at a desired (or alternatively “predetermined”) speed by a user while a touch starting point and a touch ending point are touched.

Hereinafter, example embodiments will be described in detail with reference to the accompanying drawings. Like or corresponding elements are denoted by the same reference numerals throughout the drawings and are not redundantly described here.

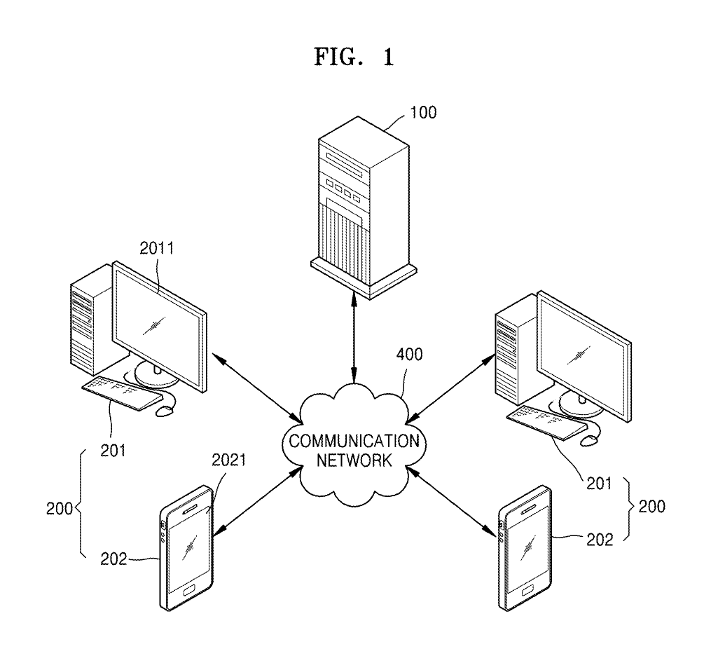

FIG. 1 is a diagram illustrating a structure of a search service providing system according to an example embodiment.

Referring to FIG. 1, the search service providing system according to an example embodiment includes a plurality of user terminals 200, a service providing server 100, and a communication network 400 via which the user terminals 200 and the service providing server 100 are connected.

A search service provided according to an example embodiment provides, for example, a search result corresponding to a search word input by a user. Here, a target to be searched for is a place. For example, a search system may provide location and/or position information of a place corresponding to a search word as a search result. The search result may include not only the location and/or position information of the place but also details about the place, e.g., the name, the telephone number, etc.

Referring to FIG. 1, the user terminals 200 mean communication terminals via which a web service may be used in a wired/wireless communication environment. According to various embodiments, user terminals 200 are physical hardware devices that are capable of running one or more applications. User terminals 200 may include a transmitter/receiver (or alternatively, a transceiver), memory, one or more processors, and/or other like components. User terminals 200 may be configured to send/receive data to/from base station 110. User terminals 200 may be designed to sequentially and automatically carry out a sequence of arithmetic or logical operations; equipped to record/store digital data on a machine readable medium; and transmit and receive digital data via base station 110. User terminals 200 may be configured to run, execute, or otherwise operate one or more applications. The applications may include native applications, web applications, and hybrid applications. User terminals 200 may include wireless phones or smartphones, desktop personal computers (PCs), laptop PCs, tablet PCs, wearable computing devices, and/or any other physical or logical device capable of recording, storing, and/or transferring digital data via a network (e.g., communication network 400).

User terminals 200 may include one or more memory devices. The one or more memory devices are a hardware devices configured to store an operating system (OS) and program code for one or more software components. The one or more memory devices may be a computer readable storage medium that generally includes a random access memory (RAM), read only memory (ROM), a flash memory device, a solid state disk (SSD), a secure digital (SD) card, and/or other like storage media capable of storing and recording data. The program code and/or software components may also be loaded from a separate computer readable storage medium into the one or more memory devices using a drive mechanism (not shown). Such separate computer readable storage medium may include a Blue-ray, DVD/CD-ROM disc drive, memory card, memory stick, removable flash drive, sim card, and/or other like computer readable storage medium (not shown). In some embodiments, software components may be loaded into the one or more memory devices via network interface, rather than via a computer readable storage medium.

User terminals 200 may include one or more processors. The one or more processors may be configured to carry out instructions of a computer program by performing the basic arithmetical, logical, and input/output operations of the system. The one or more processors may include a single-core processor, a dual-core processor, a triple-core processor, a quad-core processor, one or more digital signal processors (DSPs), application-specific-integrated-circuits, field programmable gate arrays (FPGAs) and/or the like. The one or more processors may perform a variety of functions for the user terminals 200 and may process data by executing program code, one or more software modules, firmware, middleware, microcode, hardware description languages, and/or any other like set of instructions stored in the one or more memory devices. The program code may be provided to the one or more processors by the one or more memory devices, one or more drive mechanisms (not shown), and/or via a network (e.g., communication network 400). In order to perform the variety of functions and data processing operations according to the example embodiments delineated herein, the program code and/or software components are loaded into the one or more processors. Once the program code is loaded into the one or more processors, the one or more processors may be programmed to perform the various operations and functions delineated by the program code, thereby transforming the one or more processors into a special purpose processor.

User terminals 200 may include may also include a transmitter and receiver. The transmitter and receiver may be any type of hardware device that generates or otherwise produces radio waves in order to communicate with one or more other devices. The transmitter and receiver may be coupled with an antenna (not shown) in order to transmit data to one or more other devices. The transmitter and receiver may be configured to receive digital data from one or more components of user terminals 200, and convert the received digital data into an analog signal for transmission over an air interface. The transmitter and receiver may be any type of hardware device that can receive and convert a signal from a modulated radio wave into usable information, such as digital data. The transmitter and receiver may be coupled with the antenna (not shown) in order to capture radio waves. The transmitter and receiver may be configured to send digital data converted from a captured radio wave to one or more other components of the user terminals 200. The user terminals 200 may include a transceiver (not shown) instead of transmitter and receiver, where the transceiver is a single component configured to provide the functionality of a transmitter and a receiver as discussed above. The wireless transmitter/receiver and/or transceiver may be configured to operate in accordance with one or more wireless communications protocols and/or one or more cellular phone communications protocols. User terminals 200 may be configured to operate in accordance with the Global System for Mobile Communications (GSM), Enhanced Data GSM Environment (EDGE), wideband code division multiple access (WCDMA), code division multiple access (CDMA), time division multiple access (TDMA), Bluetooth, Wireless Fidelity (Wi-Fi) such as the Institute of Electrical and Electronics Engineers (IEEE) 802.11a, IEEE 802.11b, IEEE 802.11g, IEEE 802.11ac, and/or IEEE 802.11n, voice over Internet Protocol (VoIP), Wi-MAX, Long Term Evolution (LTE), an email protocol such as Internet Message Access Protocol (IMAP) and/or Post Office Protocol (POP), an instance messaging such as eXtensible Messaging and Presence Protocol (XMPP), Session Initiation Protocol for Instant Messaging and Presence Leveraging Extensions (SIMPLE), Instant Messaging and Presence Service (IMPS), and Short Message Service (SMS), or any other “wireless” communication protocols, including RF-based, optical (visible/invisible), and so forth.

User terminals 200 may be equipped with location (or alternatively “geolocation”), positioning, and/or navigation circuitry, such as a Global Positioning System (“GPS”) receiver, as well as software to convert received GPS signals into a location and/or position (within some margin of error). In other embodiments, alternate positioning systems may be employed, such as wireless network signal-strength-based indoor positioning systems, hybrid systems combining global and local positioning systems, and/or other like positioning and/or location detection systems. However, in various embodiments, geolocation and/or positioning information may come from other sources including an IP address, Wi-Fi and/or Bluetooth MAC address, radio-frequency identification (“RFID”), Wi-Fi connection location, GSM/CDMA cell IDs, and the like.

User terminals 200 may include an accelerometer, gyroscope, gravimeter, and/or another like device that is configured to measure and/or detect a motion, an acceleration, and/or an orientation of the user terminals 200. In such embodiments, the user terminals 200 may be configured to determine a magnitude and direction of an acceleration and/or motion of the user terminals 200, and convert the acceleration and/or motion of the user terminals 200 into position and/or orientation information.

As shown in FIG. 1, the user terminals 200 may include a personal computer (PC) 201 and/or a portable terminal 202 belonging to a user. It should be noted that one or more devices that are associated with a single user may be collectively referred to as a “user terminal 200”. Although FIG. 1 illustrates the portable terminal 202 as a smart phone, example embodiments are not limited thereto and any terminal storing an application enabling web browsing may be used as the portable terminal 202 as described above.

According to various embodiments, the user terminals 200 include display units 2011 and/or 2021 displaying an image thereon, and input devices via which data is input from a user. The input devices may include, for example, a keyboard, a mouse, a track ball, a microphone, buttons, a touch panel and/or touchscreen, etc., but are not limited thereto. Furthermore, in some embodiments, the service providing server 100 may include many more components than those discussed above. However, it is not necessary that all of these generally conventional components be disclosed in order to disclose the example embodiments

The communication network 400 connects the plurality of user terminals 200 and the service providing server 100. Communication network 400 may be any network that allows computers to exchange data. Communication network 400 may include one or more network elements (not shown) capable of physically or logically connecting computers and/or network elements. As used herein, the term “network element”, may be considered synonymous to and/or referred to as a networked computer, networking hardware, network equipment, router, switch, hub, bridge, gateway, or other like device. The term “network element” may describe a physical computing device of a wired or wireless communication network and configured to host a virtual machine. Furthermore, the term “network element” may describe equipment that provides radio baseband functions for data and/or voice connectivity between a network and one or more users. In various embodiments, communication network 400 may be the Internet. In various embodiments, communication network 400 may be may be a Wide Area Network (WAN) or other like network that covers a broad area, such as a personal area network (PAN), local area network (LAN), campus area network (CAN), metropolitan area network (MAN), a virtual local area network (VLAN), or any other like network capable of physically or logically connecting computers. Additionally, in various embodiments, communication network 400 may be a private and/or secure network, which is used by a single organization (e.g., a business, a school, a government agency, and the like). The communication network 400 provides an access path so that the user terminals 200 may access the service providing server 100 and transmit packet data to or receive packet data from the service providing server 100.

Service providing server 100 is a network element that may include one or more systems and/or applications for providing one or more services. Service providing server 100 may include a processor, memory or computer readable storage medium, and a network interface. In some embodiments, service providing server 100 may include a transmitter/receiver connected to one or more antennas. The service providing server 100 may be any network element capable of receiving and responding to requests from one or more client devices (e.g., user terminals 200) across a computer network (e.g., communication network 400) to provide one or more services. Accordingly, service providing server 100 may be configured to communicate with the user terminals 200 via a wireless protocol. Additionally, service providing server 100 may be a single physical hardware device, or service providing server 100 may be physically or logically connected with other network devices, such that the service providing server 100 may reside on one or more physical hardware devices. Service providing server 100 may employ one or more connection-oriented protocols such as Session Initiation Protocol (SIP), HTTP, and TCP/IP, and includes network devices that use connectionless protocols such as User Datagram Protocol (UDP) and Internet Packet Exchange (IPX). Service providing server 100 may be configured to establish, manage, and terminate communications sessions, for example between the service providing server 100 and user terminals 200. Service providing server 100 may also be configured to establish, manage, and terminate communications sessions with two or more client devices. According to various embodiments, the user terminals 200 and the service providing server 100 may communicate with each other via a communications network 400 as described above.

Service providing server 100 may include one or more processors (not shown) and one or more data storage devices. The one or more processors may be special purpose computer processing devices configured to carry out program code stored in the one or more storage devices by performing arithmetical, logical, and input/output operations. For example, program code and/or software modules may be loaded into the one or more processors. Once the program code and/or software modules are loaded into the one or more processors, the one or more processors may be configured to perform user operations according to various example embodiments.

The one or more storage devices may be a computer readable storage medium that generally includes a random access memory (RAM), read only memory (ROM), a permanent mass storage device (such as a disk drive), and/or any other like data storage mechanism capable of storing and recording data. The one or more storage devices may be configured to store program code for one or more operating systems and/or program code for one or more software components and/or modules for performing operations according to various example embodiments. These software components may also be loaded from a separate computer readable storage medium into the one or more storage devices and/or the one or more processors using a drive mechanism (not shown). Such separate computer readable storage medium may include a floppy drive, disc, tape, Blu-ray/DVD/CD-ROM drive, memory card, removable flash memory drive, and/or other like computer readable storage medium (not shown). In some embodiments, software components may be loaded into the one or more storage devices and/or the one or more processors from a remote data storage device via a network interface, rather than via a computer readable storage medium.

Service providing server 100 may also include a transmitter and receiver. The transmitter and receiver may be any type of hardware device that generates or otherwise produces radio waves in order to communicate with one or more other devices. The transmitter and receiver may be coupled with an antenna (not shown) in order to transmit data to one or more other devices. The transmitter and receiver may be configured to receive digital data from one or more components of service providing server 100, and convert the received digital data into an analog signal for transmission over an air interface. The transmitter and receiver may be any type of hardware device that can receive and convert a signal from a modulated radio wave into usable information, such as digital data. The transmitter and receiver may be coupled with the antenna (not shown) in order to capture radio waves. The transmitter and receiver may be configured to send digital data converted from a captured radio wave to one or more other components of service providing server 100. Service providing server 100 may include a transceiver (not shown) instead of transmitter and receiver, where the transceiver is a single component configured to provide the functionality of a transmitter and a receiver as discussed above. The wireless transmitter/receiver and/or transceiver may be configured to operate in accordance with one or more wireless communications protocols and/or one or more cellular phone communications protocols. User terminals 200 may be configured to operate in accordance with the Global System for Mobile Communications (GSM), Enhanced Data GSM Environment (EDGE), wideband code division multiple access (WCDMA), code division multiple access (CDMA), time division multiple access (TDMA), Bluetooth, Wireless Fidelity (Wi-Fi) such as the Institute of Electrical and Electronics Engineers (IEEE) 802.11a, IEEE 802.11b, IEEE 802.11g, IEEE 802.11ac, and/or IEEE 802.11n, voice over Internet Protocol (VoIP), Wi-MAX, Long Term Evolution (LTE), an email protocol such as Internet Message Access Protocol (IMAP) and/or Post Office Protocol (POP), an instance messaging such as eXtensible Messaging and Presence Protocol (XMPP), Session Initiation Protocol for Instant Messaging and Presence Leveraging Extensions (SIMPLE), Instant Messaging and Presence Service (IMPS), and Short Message Service (SMS), or any other “wireless” communication protocols, including RF-based, optical (visible/invisible), and so forth

According to various embodiments, the service providing server 100 may be connected to one or more local and/or remote databases (not shown). In various embodiments, the one or more databases may include a database management system (“DBMS”), a relational database management system (“RDBMS”) database, an object database (“ODBMS”), column-oriented DBMS, correlation database DBMS, and/or other like database management systems. In various embodiments, the one or more databases may be used by the service providing server 100 to store and record video content and/or advertising content in order to recall and provide the video content and/or advertising content to a client (i.e., user terminals 200).

Furthermore, in some embodiments, the service providing server 100 may include many more components than those discussed above, such as a display device, a network interface, and/or other like physical hardware components. However, it is not necessary that all of these generally conventional components be disclosed in order to disclose the example embodiments.

The service providing server 100 according to an example embodiment receives a search word from each of the user terminals 200 and provides each of the user terminals 200 with a search service providing a search result corresponding to the search word and information regarding the search result. Although one service providing server 100 is illustrated in the embodiment of FIG. 1, a plurality of servers may be present. For example, additional service providing servers 100 may be provided according to an amount of access and/or an amount of data to be provided to user terminals 200, and/or a number of user terminals 200 requesting services from the service providing server(s) 100.

The service providing server 100 according to an example embodiment may provide a map service, in which the service providing server 100 provides information of a location and/or position on a map of a point selected by a user and/or the locations and/or positions of neighboring regions around the selected point. In various embodiments, the service providing server 100 may provide location and/or position information to user terminals 200 based on location and/or position information (e.g., GPS location information, etc.) that the user terminals 200 provide to the service providing server 100. The map service may provide not only a location search service but also various additional services related to a map (e.g., a neighboring region search service, a route search service, a public transportation search service, a venue search service, etc.).

The map service may be provided such that the map service includes the search services described above. For example, search results corresponding to the search word may be provided in the form of a list when a user inputs a search word related to a location and/or position. When the user selects an item from the list of the search results, a point corresponding to the selected item may be displayed on a map.

When user input instructing to display a selected point that is different from a point that is currently displayed on a map is input, the service providing server 100 according to an example embodiment may display a map including both the currently displayed point and the selected point in a transition state and may thereafter switch the map to a map displaying another point selected by a user.

In the following disclosure, a map including and/or displaying a specific point may mean a map displaying on a display screen the specific point and neighboring points around the specific point. A scale of the map including the specific point may vary according to the characteristics of the specific point to be displayed. For example, a scale of 1:200 may be used when the specific point is a building and a scale of 1:20000 or more may be used when the specific point is a wide area such as a city, a district, a borough, but example embodiments are not limited thereto.

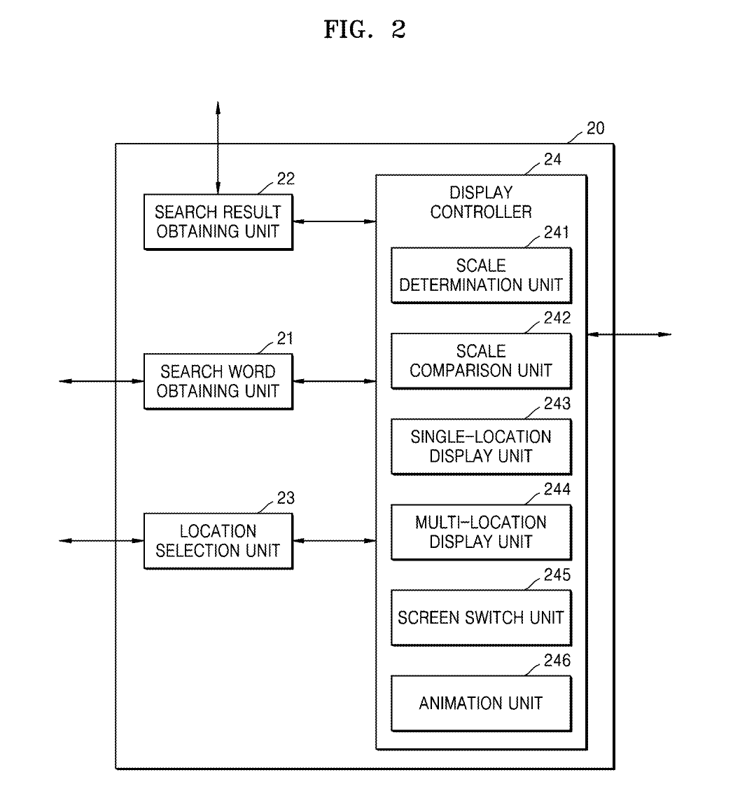

FIG. 2 is a block diagram of a structure of a search service providing apparatus 20 according to an example embodiment.

According to an example embodiment, the search service providing apparatus 20 may correspond to at least one processor. Thus, the search service providing apparatus 20 may be driven while being included in another hardware device such as a microprocessor or a general-purpose computer system. For example, the search service providing apparatus 20 may be installed in the user terminals 200 and/or the service providing server 100. In some embodiments, some elements of the search service providing apparatus 20 may be installed in the user terminals 200 while other elements may be installed in the service providing server 100. That is, the search service providing apparatus 20 may be included in one physical device or dispersed over a plurality of physical devices.

Referring to FIG. 2, the service providing apparatus 200 includes the search service providing apparatus 20 includes a search word obtaining unit 21, a search result obtaining unit 22, a location selection unit 23, and a display controller 24. The search word obtaining unit 21, the search result obtaining unit 22, the location selection unit 23, and the display controller 24 may be embodied as program code and/or software modules, hardware devices, and/or a combination thereof. For example, in various embodiments the search word obtaining unit 21, the search result obtaining unit 22, and the location selection unit 23 may be included in one or more processors, and the display controller 24 may be a processing device such as a graphics processing device (GPU) and the like, which includes the various units shown in FIG. 2 during operation.

In embodiments where the search word obtaining unit 21, the search result obtaining unit 22, the location selection unit 23, and the various units included in the display controller 24 are embodied as program code and/or software modules, in order to perform the functions of the search word obtaining unit 21, the search result obtaining unit 22, the location selection unit 23, and the various units of the display controller 24 according to the example embodiments delineated herein, the program code and/or software components may be loaded into the at least one processor and/or display controller 24. Once the program code is loaded into the at least one processor and/or display controller 24, the at least one processor and/or display controller 24 may be programmed to perform the various operations and functions delineated by the program code and/or software modules, thereby transforming the at least one processor and/or display controller 24 into special purpose processor(s).

Referring back to FIG. 2, the search word obtaining unit 21 receives a search word from the input device of the user terminal 200. The search word obtaining unit 21 outputs the search word to the search result obtaining unit 22.

The search result obtaining unit 22 obtains a place search result corresponding to the search word from the service providing server 100. In detail, the search result obtaining unit 22 transmits the search word received from the search word obtaining unit 21 to the service providing server 100, and obtains the search result from the service providing server 100. To this end, the search result obtaining unit 22 may include or may be otherwise associated with a communication interface to provide the search word and/or other like information to the service providing server 100 in the form of packet data and/or a signal to be exchanged between the service providing server 100 and the user terminal 200 via the communication network 400.

According to an example embodiment, the search result obtaining unit 22 may obtain location-based, position-based, and/or place-based search results (hereinafter referred to as “place search results”) corresponding to the search word. The place search results may each include a parameter indicating the precision thereof. The parameter may include information regarding a degree of a relation between the search word and the place search result according to desired (or alternatively “predetermined”) criteria. The desired (or alternatively “predetermined”) criteria may include, for example, a similarity between the search word and a name of the place search result, a degree of popularity of the place search result, proximity between a current location and/or current position of the user terminal 200 and the location and/or position of the place search result, and/or any other like criteria. However, the desired (or alternatively “predetermined”) criteria are just examples and example embodiments are not embodied thereto.

The search result obtaining unit 22 may further obtain place-related information, which corresponds to a place search result. Examples of the place-related information corresponding to a search result may include a name, address, telephone number, degree of popularity, category, photos, and/or any other like place-related information. This place-related information may further include the parameter indicating the degree of the relation between the search word and the place search result.

The display controller 24 controls a display device of the user terminal 200 (e.g., the display units 2011 and 2021 as discussed above with regards to FIG. 1) such that the search result obtained by the search result obtaining unit 22 is displayed together with a map thereof on the display device. According to an example embodiment, the display controller 24 may display a certain location and/or position when the search result is displayed on the map. For example, the display controller 24 may display on the display units 2011 and 2021 of the user terminals 200 a map for simultaneously displaying a location marker indicating a certain location and/or position and a result marker indicating the location and/or position of the search result. In this way, a user may be able to detect the location and/or position of the search result relative to the location and/or position indicated by the location marker.

When a plurality of search results are obtained by the search result obtaining unit 22, the display controller 24 may display on the display device a result marker indicating the location and/or position of a first search result that is mostly related to the search word (hereinafter referred to as the ‘first search result’) among a plurality of search results. The degree of the relation between each of the search results and the search word may be a value included in a parameter obtained together with each of the plurality of search results as described above.

According to an example embodiment, a location marker may indicate a current location and/or current position of a user. The current location and/or current position may be detected using a location receiver (not shown) included in the user terminal 200. The location receiver may be, for example, a global positioning system (GPS) receiver but is not limited thereto. The GPS receiver receives a signal transmitted from a GPS satellite and calculates a current location of the user terminal 200. According to various embodiments, the user terminal 200 includes the location receiver and may detect the current location and/or current position thereof. In such embodiments, the display controller 24 may display on the display device a location marker indicating the current location and/or current position calculated by the location receiver. In this way, a user is able to detect a location and/or position of a search result relative to a current location and/or current position of the user terminal 200.

According to various example embodiments, a location marker may indicate a location and/or position selected by a user. For example, the location marker may indicate one of a plurality of locations and/or positions registered with a bookmark menu. The user may select one of the plurality of locations and/or positions registered with the bookmark menu by using the input device.

To this end, the search service providing apparatus 20 according to an example embodiment may further include a location selection unit 23. The location selection unit 23 may receive from the input device an input signal for selecting one of the plurality of locations and/or positions registered with the bookmark menu, and select a location and/or position indicated by a location marker based on the input signal. According to the various example embodiments, a user may detect the location and/or position of a search result relative to a selected location and/or selected position.

According to an example embodiment, the display controller 24 may include a scale determination unit 241 and a scale comparison unit 242.

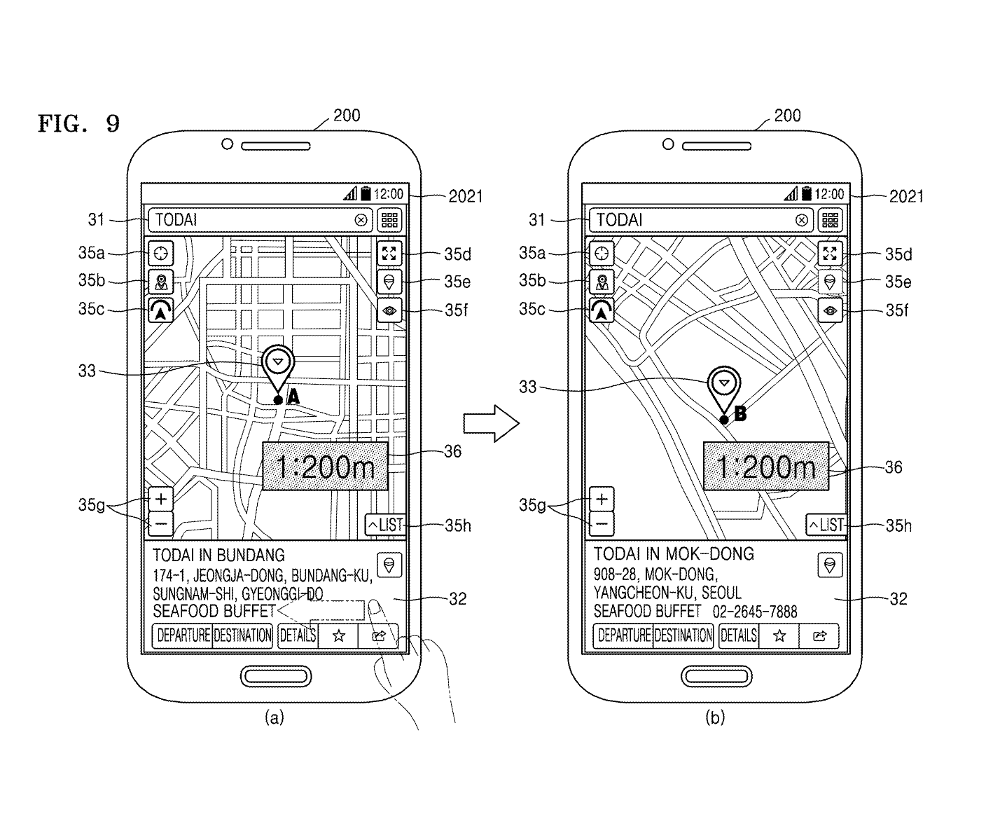

The scale determination unit 241 determines a scale of a map to simultaneously display a first point and a second point on the display unit of the user terminal 200. For example, the first point may be a point indicated by a location marker and the second point may be a point indicated by a result marker. That is, the scale determination unit 241 may determine a scale of a map to display the first and second points on one map on the same screen. The display controller 24 displays the location marker and the result marker on a map, the scale of which is determined by the scale determination unit 241. By way of another example, the first point may be a point on a currently displayed map, and the second point may be another point selected by a user while the map displaying the first point is displayed. For example, referring to FIG. 9 which will be described below, the first point may be ‘Todai in Bundang’ and the second point may be ‘Todai in Mok-dong’.

The display controller 24 displays the first and second points on a map of a scale determined by the scale determination unit 241.

For example, the scale determination unit 241 may calculate or otherwise determine a region, diagonal vertices that correspond to the first and second points, and a scale of a map to display the calculated and/or determined region on one screen as a scale of a map to be displayed on the display device. The scale determination unit 241 may determine as a scale of a map a maximum scale among a plurality of scales for displaying the calculated and/or determined region on one screen. Otherwise, a scale that is lower by at least one level than the maximum scale may be determined as the scale of the map. Here, the scale of the map displayed on the display device may be a desired (or alternatively “predetermined”) scale as, such as, 1:100, 1:200, 1:400, and/or the like.

Even if the scale of the map is the same, the size of a region that is to be displayed on a screen may vary according to the size of the display device for displaying the screen. Thus, the scale determination unit 241 may consider the size of the display device of the user terminal 200 to determine a scale of a map for displaying the region within one screen. The size of the display device may be calculated and/or determined from the horizontal/vertical resolution (i.e., the number of pixels) of the display device of the user terminal 200 and/or pixels per inch (PPD. In various embodiments, the size of the display device may be obtained from specification information of the user terminal 200. A method of obtaining information regarding the size of a display unit is, however, not limited thereto.

The region may be determined in consideration of the shape of the display device. For example, when the display device has a square shape, the region may be a square region. In this case, the scale determination unit 241 may calculate the square region, the diagonal vertices respectively correspond to the first and second points, and determine a scale for displaying the calculated square region on one screen as a scale of a map to be displayed on the display device.

However, when the display device has a shape other than the square shape, the scale determination unit 241 may determine a scale of a map in consideration of the shape of the display device.

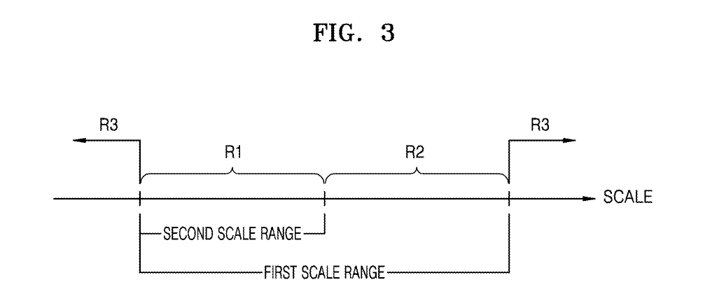

The scale comparison unit 242 detects whether the scale determined by the scale determination unit 241 is within a preset and/or desired scale range, and the display controller 24 displays both the first and second points or only the second point, based on a result of detecting whether the scale is within the desired (or alternatively “predetermined”) scale range. For convenience of explanation, results of comparing scales are described with regards to FIG. 3.

First, the scale comparison unit 242 detects whether the scale determined by the scale determination unit 241 is within a preset and/or desired first scale range.

The first scale range may be set in consideration of whether a user can easily detect an absolute or relative location and/or position of a region displayed on a map. The first scale range may be set to include an upper limit and a lower limit (e.g., from 1:25 to 1:1600, and the like). Alternatively, the first scale range need not include both the upper limit and the lower limit, and therefore, in some embodiments the first scale range may include only the upper limit or the lower limit.

Persons having ordinary skill in the art should recognize that the upper limit and the lower limit of the first scale range may be variously set according to a situation in which the current embodiment is performed. For example, the first scale range may be set in consideration of at least one among the size and resolution of the display device of the user terminal 200. For example, when the resolution of the user terminal 200 is equal to or greater than a reference level (e.g., when the resolution of the display device of the user terminal 200 is 800 pixels or more in a horizontal line), the first scale range may be adjusted to be increased by one or more levels.

First, when the scale determination unit 241 determines that the scale is within the first scale range (see R1 and R2 of FIG. 3), the display controller 24 may display a first point and a second point on a map of the scale determined by the scale determination unit 241. For example, when the scale determined by the scale determination unit 241 is 1:400 and the first scale range is from 1:25 to 1:1600 (see R2 of FIG. 3), the display controller 24 may display the first point and the second point on a map of a scale of 1:400.

When the scale determination unit 241 determines that the scale is within the first scale range as described above, the scale comparison unit 242 may further compare whether the scale determined by the scale determination unit 241 is within a second scale range. As shown in FIG. 3, the second scale range is within the first scale range. For example, the second scale range may be from 1:200 to 1:1600 when the first scale range is from 1:25 to 1:1600 but example embodiments are not limited thereto. In various embodiments, the second scale range may be set in consideration of at least among the size and resolution of the display device of the user terminal 200.

When the scale determined by the scale determination unit 241 is within the second scale range (see R1 of FIG. 3), the display controller 24 may display the first point and the second point on a map of the determined scale. For example, when the scale determined by the scale determination unit 241 is 1:400 and the second scale range is from the 1:200 to 1:1600, the display controller 24 displays the first point and the second point on a map of the scale of 1:400.

When the scale determined by the scale determination unit 241 is not within the second scale range (see R2 of FIG. 3), the display controller 24 may display the first point and the second point on a map of a scale ranging between upper and lower limits of the second scale range. For example, when the scale determined by the scale determination unit 241 is 1:25 and the second scale range is from 1:200 to 1:1600, the display controller 24 may display the first point and the second point on a map of a scale of 1:200.

Next, when the scale determination unit 241 determines that the scale is not within the scale range (see R3 of FIG. 3), the display controller 24 may display a map on which the second point is displayed. In this case, it may be inappropriate to simultaneously display the first point and the second point on the same screen. In various embodiments, the display controller 24 may display the second point on a map of a basic scale. The basic scale may be set and stored beforehand. The basic scale may be, for example, 1:200, 1:400, etc., but example embodiments are not limited thereto.

According to an example embodiment, the display controller 24 may further determine whether a search result (or a first search result when a plurality of search results are present) corresponds to a main place, so as to control displaying on the display device. The search result obtaining unit 22 may obtain information regarding a search result while obtaining the search result from the service providing server 100. The search result obtaining unit 22 may output the information regarding the search result when the search result is output to the display controller 24. This information may contain information indicating whether the search result corresponds to a main place.

A list of main places may be registered beforehand with the service providing server 100. The service providing server 100 may further output information regarding a search result in consideration of the list of main places registered therewith when the service providing server 100 obtains the information regarding the search result from the search result obtaining unit 22 and outputs the search result. For example, information indicating whether the search result corresponds to a main place may be output in addition to, or alternatively to, the information of the search result. The list of main places registered with the service providing server 100 may include information regarding a best scale for displaying each of the main places. Thus, the service providing server 100 may further output information regarding a best scale for displaying a main place as information regarding the search result when the search result corresponds to the main place. The main place may be a place that is frequently searched for, such as a famous place, venue, landmark, location and/or position, and the like. Examples of the main place may include Halla mountain, Sorak mountain, Baekdu mountain, Jeju-do, the N Seoul tower, etc.

When the search result does not correspond to a main place, the display controller 24 may display both a first point and a second point or only the second point on a screen as described above with reference to FIG. 3.

However, in various embodiments, when the search result corresponds to a main place, the display controller 24 may display the second point on a map without the first point. In this case, the map may be a map of a basic scale. However, according to various embodiments, information regarding a search result may further include information regarding a best scale appropriate for displaying the search result when the search result corresponds to a main place. Also, the display controller 24 may display the second point on a map of the best scale.

As described above, according to various example embodiments, a first point and a second point may be displayed on a map of an appropriate scale that does not have a relatively small and/or a relatively large scale, and a user may detect a location and/or position of a region displayed on the map and locations and/or positions of the first point and the second point on the map.

In the above example embodiments, a single-location display unit 243 of the display controller 24 may provide a screen when one point is to be displayed on one map, and a multi-location display unit 244 of the display controller 24 may provide a screen when a plurality of points are to be displayed on one map.

According to an example embodiment, the display controller 24 may switch a display screen from a first state to a second state and then from the second state to a third state in order to display the first and second points. Such a screen switch interface will be referred to as a map transition interface. The first point may be displayed in the first state. The second state may be a transition state in which both the first and second points are displayed. The second point may be displayed in the third state. Screens in the first and third states may be provided by the single-location display unit 243, and a screen in the second state may be provided by the multi-location display unit 244. For a map transition animation, the display controller 24 according to an example embodiment may further include a screen switch unit 245 and an animation unit 246. Functions of the screen switch unit 245 and the animation unit 246 will be described in detail with reference to FIGS. 9 to 14, based on a screen displayed on one of the user terminals 200.

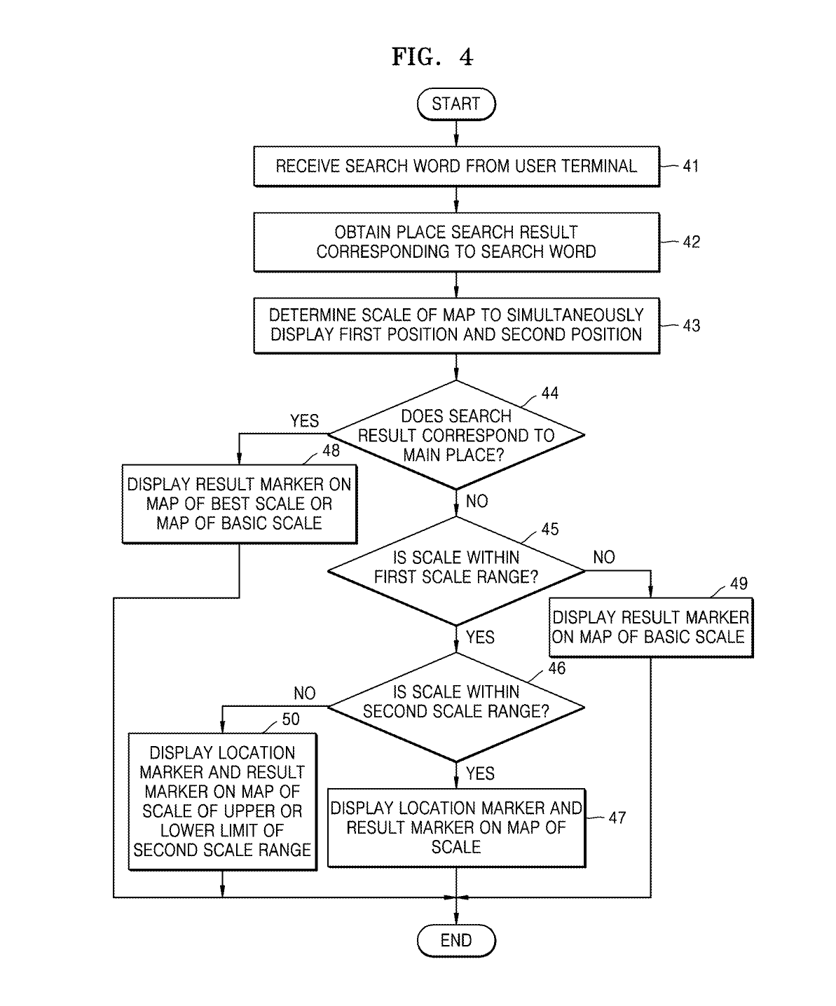

FIG. 4 is a flowchart of a method of providing a search service according to an example embodiment. For illustrative purposes, the method of providing the search service is described as being performed by the components of the search service providing apparatus 20. However, it should be noted that any hardware computing device that has a same or similar configuration as the search service providing apparatus 20 (or includes a same or similar device as the search service providing apparatus 20) may also perform the method of providing the search service.

Referring to FIGS. 2 and 4, in operation S41, the search word obtaining unit 21 receives a search word from the user terminal 200.

In operation S42, the search result obtaining unit 22 obtains a place search result corresponding to the search word. In various embodiments, the search result obtaining unit 22 may obtain a plurality of place search results corresponding to the search word. In various embodiments, the search result obtaining unit 22 may further obtain place-related information regarding the place search result together with the place search result. The place-related information may include, for example, a name, address, telephone number, degree of popularity, a category, photos, and/or any other like place-related information. The information may further include a parameter indicating the degree of a relation between the search result and the search word. The information may further include information indicating whether the search result corresponds to a main place. When the search result corresponds to a main place, the information may further include information regarding a desired scale for displaying the main place.

In operation S43, the scale determination unit 241 determines a scale of a map to simultaneously display a first point and a second point. The first point may be a point pointed to or otherwise indicated by a location marker indicating a desired (or alternatively “predetermined”) location and/or position, and the second point may be a point pointed to or otherwise indicated by a result marker indicating the location and/or position of the search result obtained in operation S42. For example, the scale determination unit 241 may determine a scale enabling a square region, the diagonal vertices that correspond to the first point and the second point to be displayed on one screen of the display unit of the user terminal 200, as a scale of a map. In various embodiments, the scale determination unit 241 may consider the size of the display unit of the user terminal 200.

The desired (or alternatively “predetermined”) location and/or position indicated by the first point (e.g., the location marker), may be a current location of a user. The current location and/or current position of the user may be detected by the location receiver (e.g., a GPS receiver), which is included in the user terminal 200. According to another embodiment, the desired (or alternatively “predetermined”) location and/or position may be selected by the user. For example, the user may select one of a plurality of locations and/or positions registered with a bookmark menu and the location marker may indicate the selected location and/or selected position.

In various embodiments, when a plurality of search results are obtained in operation S42, the result marker may indicate the location and/or position of the search result that is mostly related to the search word among the plurality of search results.

In operation S44, the display controller 24 detects or otherwise determines whether the search result corresponds to a main place. When the search result does not correspond to the main place, operation S45 is performed.

If in operation S44 the display controller 24 detects or otherwise determines that the search result does not correspond to a main place, the display controller 24 proceeds to operation S45 to provide a result of the determination to the scale comparison unit 242. In operation S45, the scale comparison unit 242 detects or otherwise determines whether the scale determined in operation S43 is within a first scale range. The first scale range may include an upper limit and/or a lower limit. The first scale range may be set in consideration of the size and/or resolution of the display device of the user terminal 200. When the scale determined in operation S43 is within the first scale range, the scale comparison unit 242 proceeds to operation S46.

In operation S46, the scale comparison unit 242 detects or otherwise determines whether the scale determined in operation S43 is within a second scale range. In various embodiments, the second scale range may be within the first scale range and may include an upper limit and/or a lower limit. The second scale range may be set in consideration of the size and/or the resolution of the display device of the user terminal 200. When the scale determined in operation S43 is within the second scale range, the scale comparison unit 242 proceeds to operation S47.

In operation S47, the display controller 24 controls the display unit of the user terminal 200 to display the location marker and the result marker on a map of the scale determined in operation S43.

Referring back to operation S44, if in operation S44 the display controller 24 detects or otherwise determines that the search result does correspond to a main place, the display controller 24 proceeds to operation S48. In operation S48, the display controller 24 displays the result marker on the map. The scale of the map on which the result marker is displayed may be a desired scale or a basic scale.

Referring back to operation S45, when the scale comparison unit 242 detects or otherwise determines that the scale determined in operation S43 is not within the first scale range, the scale comparison unit 242 proceeds to operation S49. In operation S49, the display controller 24 displays the result marker on a map of with a basic scale.

Referring back to operation S46, when the scale comparison unit 242 detects or otherwise determines in operation S46 that the scale determined in operation S43 is not within the second scale range, the scale comparison unit 242 proceeds to operation S50. In operation S50, the display controller 24 displays the location marker and the result marker on a map of a scale which is the upper or lower limit of the second scale range.

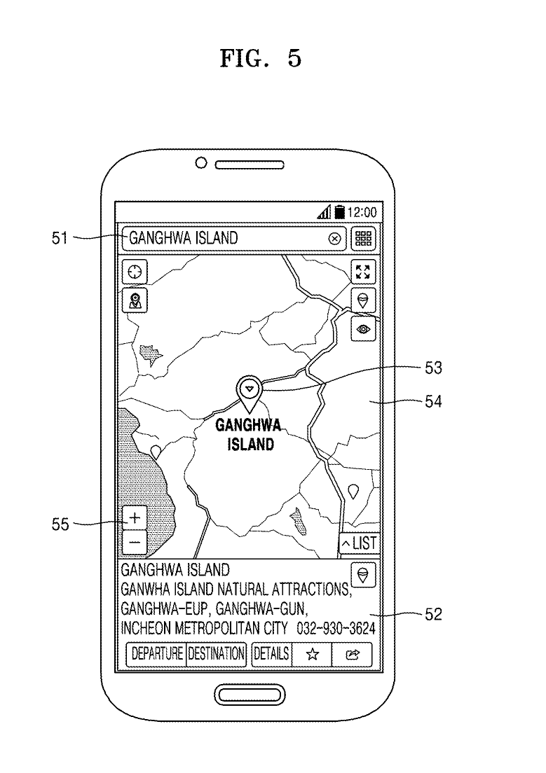

Example embodiments in which screens provided by a search service providing system according to various example embodiments are displayed on a user terminal 200 will be described with reference to FIGS. 5 to 13 below.

FIG. 5 illustrates an example embodiment in which a screen provided by a search service providing system is displayed on a user terminal 202. It should be noted that the example embodiment illustrated by FIG. 5 may also be displayed on any of the user terminals 200 and/or any other like computing device. FIG. 5 illustrates a screen illustrating that a search word is ‘Ganghwa Island’ and a search result corresponding to the search word corresponds to a main place. In various embodiments, the search result may be a first search result of a plurality of search results that correspond to the main place.

Referring to FIG. 5, an input search word 51 is ‘Ganghwa Island’ and a search result 52, which corresponds to the search word 51. In various embodiments, the search result 52 may be a first search result of a plurality of search results that corresponds to the search word 51. Also, a result marker 53 indicating a location and/or position of the search result 52 is displayed on a map 54.

In the example embodiment shown by FIG. 5, since the search result 52 corresponds to a main place, only the result marker 53 is displayed on the map 54. A scale of the map 54 may be a best and/or a desired scale for displaying the search result 52. In some embodiments, the scale of the map 54 may be a basic scale that is not related to the search result 52. FIG. 5 illustrates the map 54 of a best scale for displaying ‘Ganghwa Island’. For example, the best scale may be about 1:32000. A scale adjustment button 55 may be clicked to change the scale (not shown).

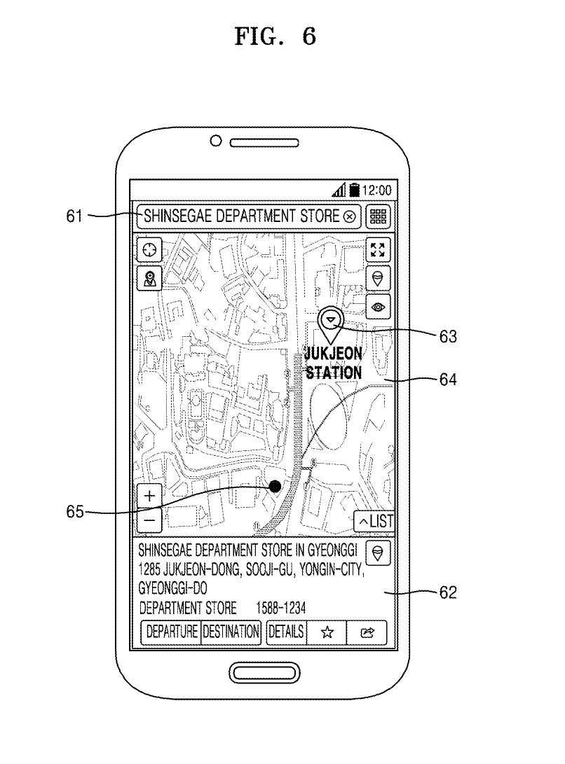

FIG. 6 illustrates another example embodiment in which a screen provided by a search service providing system is displayed on a user terminal 202. It should be noted that the example embodiment illustrated by FIG. 6 may also be displayed on any of the user terminals 200 and/or any other like computing device. FIG. 6 illustrates a screen showing that a search word is ‘Shinsegae Department Store’ and a search result corresponding to the search word does not correspond to a main place. In various embodiments, the search result may be a first search result of a plurality of search results that do not correspond to the main place.

In the example embodiment shown by, FIG. 6, an input search word 61 is ‘Shinsegae Department Store’ and a search result 62 corresponds to the search word 61. In various embodiments, the search result 62 may be a first search result of a plurality of search results that correspond to the search word 61. A result marker 63 indicating a location and/or position of the search result 62 and a location marker 65 indicating a desired (or alternatively “predetermined”) location and/or position is displayed on a map 64. The location marker 65 may indicate a current location and/or current position of a user terminal 202/200 or a selected location and/or selected position selected by the user.

Since FIG. 6 illustrates an example embodiment in which the search result 62 does not correspond to a main place, it is considered whether a scale for simultaneously displaying the result marker 63 and the location marker 65 on the map 64 is within a desired (or alternatively “predetermined”) scale range. In FIG. 6, the scale is about 1:800 and both the first scale range and the second scale range of FIG. 3 are satisfied (see R1 of FIG. 3).

Referring to FIG. 6, the location and/or position of the search result 62 indicated by the result marker 63 relative to the desired (or alternatively “predetermined”) location and/or position indicated by the location marker 65 may be checked on a map of an appropriate scale displayed on one screen. That is, a user may detect a location and/or position of a place, which is to be searched for, relative to a current location and/or current position thereof.

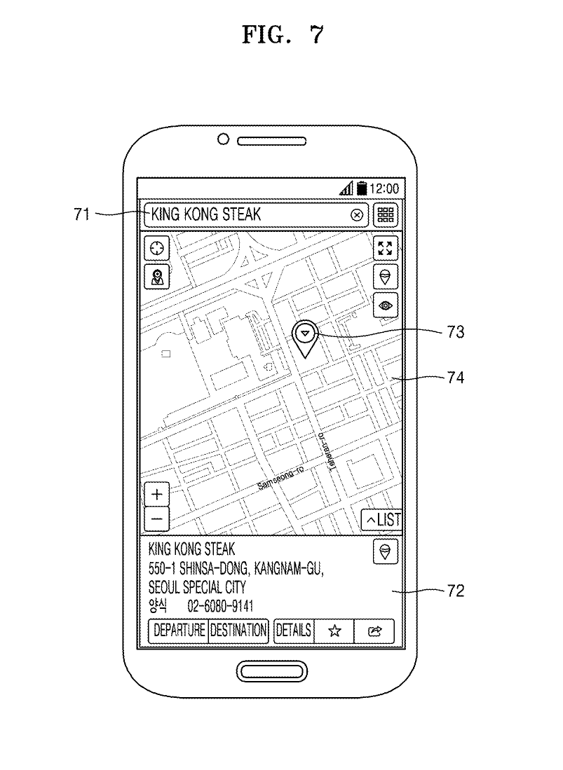

FIG. 7 illustrates another example embodiment in which a screen provided by a search service providing system is displayed on a user terminal 202. It should be noted that the example embodiment illustrated by FIG. 7 may also be displayed on any of the user terminals 200 and/or any other like computing device. FIG. 7 illustrates a screen showing that a search word is ‘King Kong Steak’ and a search result corresponding to the search word does not correspond to a main place. In various embodiments, the search result may be a first search result of a plurality of search results that do not correspond to the main place.

Referring to FIG. 7, an input search word 71 is ‘King Kong Steak’ and a search result 72 that corresponds to the search word 71. In various embodiments, the search result 72 may be a first search result of a plurality of search results that correspond to the search word 71.

Since FIG. 7 illustrates an example embodiments in which the search result 62 does not correspond to a main place, it is considered whether a scale for simultaneously displaying a result marker 73 and a location marker (not shown) on a map 74 is within a desired (or alternatively “predetermined”) scale range. FIG. 7 illustrates a screen showing an example embodiment in which the scale for simultaneously displaying the result marker 73 and the location marker is not within a first scale range (e.g., R3 of FIG. 3).

Thus, according to the example embodiment of FIG. 7, only the result marker 73 indicating the location of the search result 72 is displayed on the map 74. In FIG. 7, a basic scale of 1:400 is illustrated as an example.

Although not shown in the drawings, a screen of the scale R2 of FIG. 3 is similar to the screen of FIG. 7 except for the scales thereof. That is, although a location marker and a result marker may be displayed on one map on the screen of the scale R2 of FIG. 3 and the screen of FIG. 7, the scale R2 of FIG. 3 may be displayed as an upper or lower limit of the second scale range.

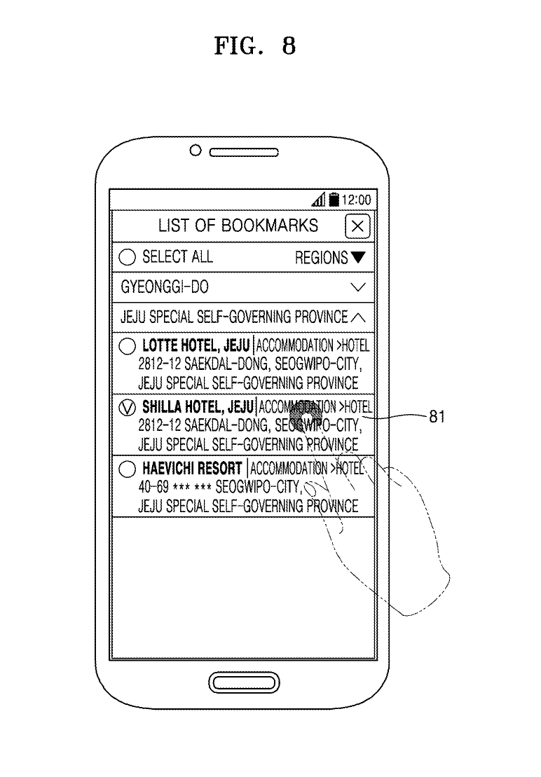

FIG. 8 illustrates a location marker selection screen provided by a search service providing system and displayed on a user terminal 202 according to an example embodiment. It should be noted that the example embodiment illustrated by FIG. 8 may also be displayed on any of the user terminals 200 and/or any other like computing device.

Referring to FIG. 8, a user may select a location and/or a position to be displayed as a location marker by selecting a place 81 among a plurality of places registered with a bookmark menu.

FIG. 9 illustrates a map service screen according to an example embodiment. As illustrated in FIG. 9, a map service provided from the service providing server 100 of FIG. 1 may be displayed on a screen of a display unit of a user terminal 200.

According to an example embodiment, a map service may cause a search window 31, a location information region 32, a selected location marker 33, buttons 35a to 35g, and a scale region 36 to be displayed on the display screen 2021, together with a map. The buttons 35a to 35g include a current location button 35a that causes information regarding a current location and/or current position when it is selected, a location designation button 35b for allowing a user to designate a location and/or position, a location change button 35c for changing a direction and/or orientation when a location and/or position movement occurs, an whole-screen button 35d for providing a whole screen, a street view button 35e for providing a street view screen, an aerial view button 35f for providing an aerial view screen, a zoom-in/out button 35g for zooming in or out a map, and a list button 35h for displaying a list of locations and/or positions.

The search window 31 is a window in which a user may input a location search word. The location information region 32 is a region in which information of a location and/or position is provided, and may provide the name of a location and/or position, the address of a location and/or position, and buttons for selecting other additional services. Referring to FIG. 9, location information of a location selected by a user is displayed in the location information region 32, a map including a point and/or position corresponding to the selected location and/or selected position is displayed on the display screen 2021, and the selected location marker 33 indicating the selected location is displayed on the selected location and/or selected position on the map. In FIG. 9(a), the selected location and/or position is ‘Todai in Bundang’ and information (e.g., the address, telephone number, etc.) regarding ‘Todai in Bundang’ is provided in the location information region 32. A selected point A corresponding to ‘Todai in Bundang’ and the selected location marker 33 for the selected point A are displayed on the map.

In embodiments where the user terminal 200 includes a touchscreen display device, a user of user terminal 200 may perform a flick gesture on the location information region 32 to display a point and/or position other than a point and/or position displayed on the location information region 32. That is, when the first point A corresponding to a first location and/or position (‘Todai in Bundang’) that is currently selected by the user is displayed on the map as illustrated in FIG. 9(a), the user may perform a flick gesture to display a second point and/or position corresponding to a second location and/or position (‘Todai in Mok-dong’) on the map as illustrated in FIG. 9(b). The second location and/or position may be a location item and/or position item next to the first location in a list of searched locations.

The selected location marker 33 is a pointer that represents in the form of an icon a point and/or position corresponding to a location and/or position selected by a user so that the selected point and/or selected position may be recognized on the map. A scale of a currently displayed map is displayed in the scale region 36. The scale region 36 is not indispensable element and may be omitted in various example embodiments.

Referring to FIG. 9, a user may select the list button 35h to view a list of locations and/or positions listed in a search result related to a search word ‘Todai’ that is input by the user. When the user inputs the search word ‘Todai’ in the search window 31, the search word obtaining unit 21 of FIG. 2 obtains the search word ‘Todai’ input in the search window 31 and the search result obtaining unit 22 of FIG. 2 provides a list of locations searched based on the search word. In various embodiments, location information of a first item in the list of locations and/or positions may be displayed in the location information region 32, and the first point A corresponding to ‘Todai’ may be displayed on the map. In this case, the user may select the list button 35h to receive a list of locations and/or positions corresponding to another search result of searching for the keyword ‘Todai’.

According to an example embodiment, the display controller 24 may provide a transition interface when a map including the first point A is switched to a map including the second point B.

The existing map services provide an interface for rapidly switching the map including the first point A to the map including the second point B, for example, an interface for rapidly switching the screen of FIG. 9(a) to the screen of FIG. 9(b). In such embodiments, a user may not know information regarding how far the first point A is from the second point B and/or a direction in which the first point A is distant from the second point B.

In order to solve this problem, according to an example embodiment, the display controller 24 of FIG. 2 displays a map including both the first point A and the second point B when the first point A and the second point B may be displayed on a map in a first scale, and individually displays a map including the first point A and a map including the second point B while displaying a transition-state map between the maps when the first point A and the second point B cannot be displayed on a map in the first scale based on a result of performing processing by the scale determination unit 241 and the scale comparison unit 242. That is, according to an example embodiment, the display controller 24 may maintain a map screen when the second point B is within a range of a map including the currently displayed first point A, and display a transition state to provide an intuitive interface when the second point B is not within the range of the map including the currently displayed first point A. A screen change may be performed sequentially, for example, from a first state in which the first point A is displayed to a second state (i.e., a transition state) in which both the first point A and the second point B are displayed, and finally, to a third state in which the second point B is displayed. In various embodiments, the third state may only include the second point B and not the second point A. The screen change will be described in more detail with reference to an internal structure of the display controller 24 below.

First, the single-location display unit 243 of FIG. 2 may provide a screen of the first state and a screen of a third state. A scale used for the single-location display unit 243 to display a map may be a basic scale used to represent a location or a basic scale used to display a corresponding point. The single-location display unit 243 may display points on separate maps in the first state and the third state described above, respectively.

FIG. 9 is a diagram illustrating points and/or positions corresponding to selected locations and/or positions that are displayed by the single-location display unit 243. The screen of FIG. 9(a) is a map displayed by the single-location display unit 243 when a user selects ‘Todai in Bundang’ as a desired location and/or desired position. The screen of FIG. 9(b) is a map displayed by the single-location display unit 243 when the user selects ‘Todai in Mok-dong’ as a desired location and/or desired position. As described above, the user may change a selected location by making a flick gesture on the location information region 32. In other words, when the user performs a flick gesture on the location information region 32 in the state of the screen of FIG. 9(a), the selected location is switched from ‘Todai in Bundang’ to ‘Todai in Mok-dong’ and a map including a second point B corresponding to ‘Todai in Bundang’ is displayed on the screen of FIG. 9(b).

The single-location display unit 243 may use a large scale to display a point corresponding to a selected location in relatively detail. For example, referring to FIG. 9, a map is displayed in a scale of 1:200 which may be considered a basic scale.

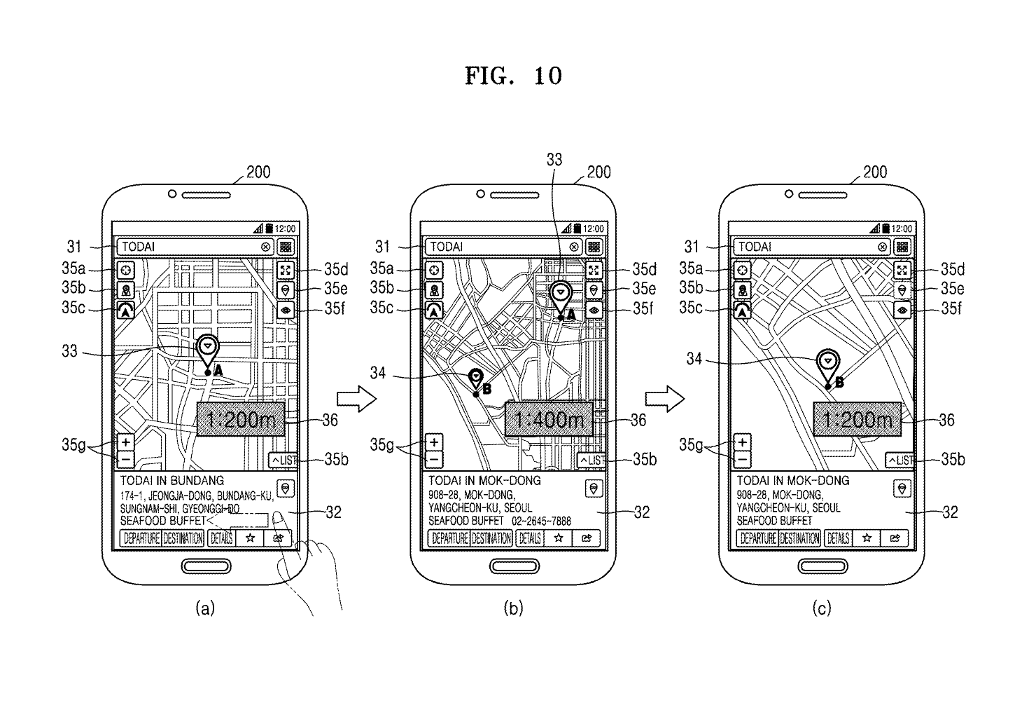

The multi-location display unit 244 may provide a screen of the second state (i.e., the transition state). A case in which a screen of the second state (i.e., the transition state), is provided from the multi-location display unit 244 is illustrated in FIG. 10.

FIG. 10 is a diagram illustrating a screen provided from a search service providing system and displayed on a user terminal according to another example embodiment. FIG. 10 illustrates ‘Todai in Bundang’ as a first point A, ‘Todai in Mok-dong’ as a second point B, and a process of switching between screens to display the first point A and the second point B, which is performed by the display controller 24 of FIG. 2.

Referring to FIG. 10, the screen switch unit 245 of FIG. 2 may switch from a screen of FIG. 10(a) to a screen of FIG. 10(b) and from the screen of FIG. 10(b) to a screen of FIG. 10(c). The screens of FIGS. 10(a) and (c) may be provided by the single-location display unit 243 of FIG. 2, and the screen of FIG. 10(b) may be provided by the multi-location display unit 244 of FIG. 2.

In the example embodiment of FIG. 10, a first scale for displaying a first point and/or position may be 1:200, a second scale for simultaneously displaying the first point and the second point may be 1:400, and a third scale for displaying the second point and/or position may be 1:200. Although the first point A is displayed in the first scale in the screen of FIG. 10(a), both the first point A and the second point a B cannot be displayed on one map in the first scale. Thus, when a user performs a flick gesture on the location information region 32 to select a location corresponding to the second point B, a map including the second point B should be newly loaded as in the screen of FIG. 10(c).

According to various example embodiments, before the screen of FIG. 10(a) is switched to the screen of FIG. 10(c), a map of a transition state as illustrated in FIG. 10(b) is displayed. The screen of FIG. 10(b) displays a map of a second scale that is less than the first scale to include both the first point A and the second point B. A user may be able to determine relative locations and/or positions and relative distances between the first point A and the second point B by using the screen of FIG. 10(b).

According to various example embodiments, when a screen of the first scale is switched to a screen of the second scale, the animation unit 246 displays an animation that shows a process of changing a map in consecutive sequences to display a map such that a scale may continuously increase or decrease. In more detail, the animation unit 246 may display a process of switching the map of FIG. 10(a) to the map of FIG. 10(b) in consecutive sequences. In such embodiments, since the second scale is less than the first scale, the animation unit 246 may provide a zoom-out animation. However, it should be noted that any type of animation may be used to switch between the first scale and the second scale.

In various embodiments, the animation unit 246 may also display a process of switching the map of FIG. 10(b) to the map of FIG. 10(c) in consecutive sequences. In such embodiments, since the third scale is greater than the second scale, the animation unit 246 may provide a zoom-in animation. However, it should be noted that any type of animation may be used to switch between the second scale and the third scale.

With the screen switch unit 245 and the animation unit 246, a user may be provided with a map transition interface for switching from a map displaying a first point A to a map displaying a second point B. With the map transition interface according to various example embodiments, the user may feel or otherwise visualize as if the user has moved upward in the air to be higher than a location and/or position where the user views the first point A (through the zoom-out animation), checked both locations and/or positions of the first point A and the second point B (display of a transition state), and moved downward to a location and/or position where the user views the second point B (through the zoom-in animation). In particular, the user may determine a relative location and/or position between the first point A and the second point B based on a map in a transition state.

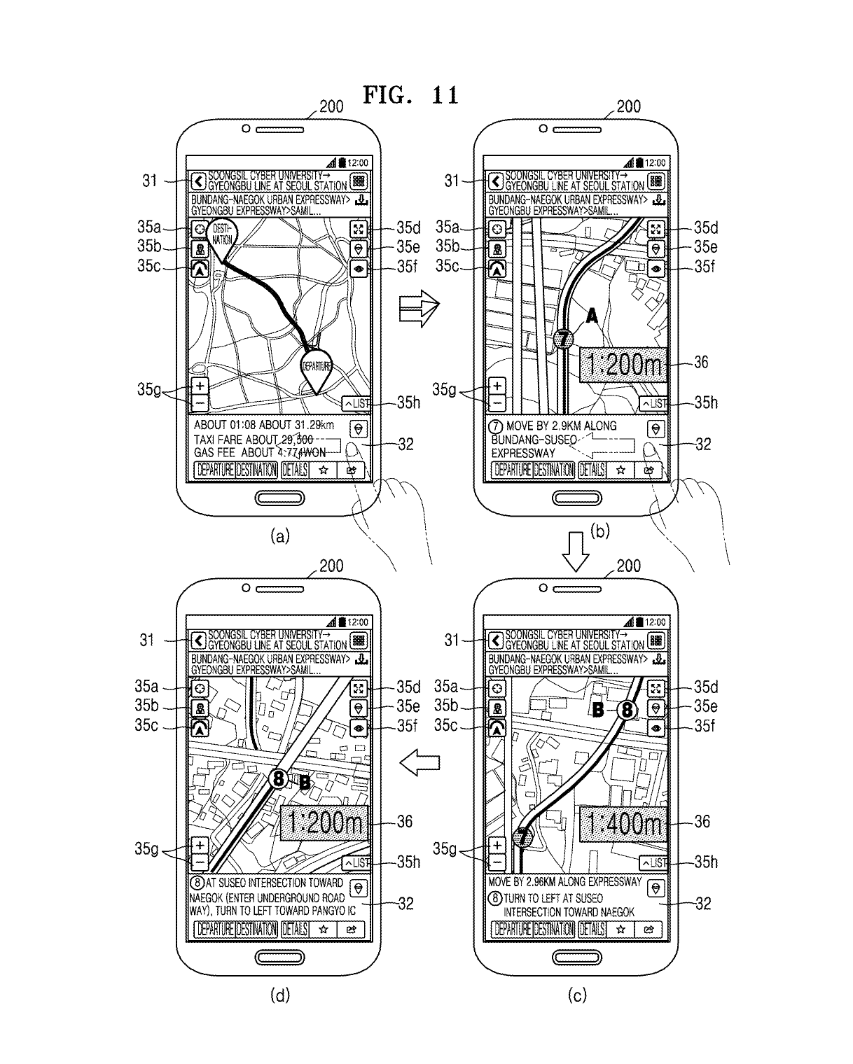

FIG. 11 illustrates a map transition interface representing a transition state according to an example embodiment.

FIG. 11 is a diagram illustrating a route search function included in a map service other than a general location search function, according to an example embodiment. When a user inputs a point of departure and a destination location and/or position, the user may be provided with information regarding a route from the point of departure to the destination location and/or position. In various embodiments, junctions in the route from the point of departure to the destination location and/or position may include a list of locations. The junctions may indicate a turn-by-turn navigation from the point of departure to the destination location and/or position.

FIG. 11(a) illustrates a map representing a whole route from a point of departure to a destination location and/or position when a user selects ‘Soongsil cyber university’ as the point of departure and ‘the Gyeongbu line at Seoul Station’ as the departure location and/or position. In various embodiments, an estimated time and/or costs required for the whole route or portions of the route may be displayed in the location information region 32. Additionally, in various embodiments, a departure marker and a destination marker may be displayed on the map. Junctions present in the whole route and/or one or more portions of the route may be sequentially designated as selected locations and/or positions when a user performs a flick gesture on the location information region 32 of the screen of FIG. 11(a) from the right to the left.

In various embodiments, the service providing server 100 may provide information regarding a route by sequentially assigning numbers to junctions in the detailed route in the order of a point of departure to a destination. The junctions in the route are sequentially provided in the form of a list of locations and/or positions. The junctions may be points at which a direction and/or orientation change occurs in the route, important points on a map, the names of roads or places on the map, etc. When a user performs a flick gesture the location information region 32, the junctions present in the list of locations and/or positions are sequentially designated as selected locations and/or positions.

FIG. 11(b) is a diagram illustrating a case in which a seventh junction is designated as a selected location and/or position in the route. casein various embodiments, the single-location display unit 243 displays the seventh junction and neighboring regions around the seventh junction on the map in a first scale of 1:200 which is a basic scale, and locates a first point A corresponding to the seventh junction at the center of the map. In the example of FIG. 11, the seventh junction is ‘Bundang-Suseo expressway’.

A user may perform a flick gesture the location information region 32 on the screen of FIG. 11(b) to designate an eighth junction as a selected location and/or position. In this case, a map of a transition state is displayed as illustrated in FIG. 11(c).

Referring to FIG. 11(c), the multi-location display unit 244 displays a map of a transition state on which both the seventh junction and the eighth junction are displayed. In a map screen of FIG. 11(c), both the first point A corresponding to the seventh junction and a second point B corresponding to the eighth junction are displayed. The multi-location display unit 244 may display a map of 1:400 which is a second scale so that the first point A and the second point B may be simultaneously displayed.

The animation unit 246 may provide a zoom-out animation when the screen of FIG. 11(b) is switched to the screen of FIG. 11(c). Through the zoom-out animation, a user may feel or otherwise visualize that the user has moved to a place higher than a point where the user views the screen of FIG. 11(b) to view the first point A and the second point B together.

After the screen of FIG. 11(c) is displayed for a desired (or alternatively “predetermined”) time, the single-location display unit 243 may display the eighth junction in a third scale as illustrated in FIG. 11(d). In this case, the third scale may be 1:200 a basic scale. In the screen of FIG. 11(d), the single-location display unit 243 may locate the second point B corresponding to the eighth junction at the center of the map.

The animation unit 246 may provide a zoom-in animation when the screen of FIG. 11(c) is switched to the screen of FIG. 11(d). Through the zoom-in animation, the user may feel or otherwise visualize that the user has moved to a point lower than a point where the user views the screen of FIG. 11(c) to view only the second point B.

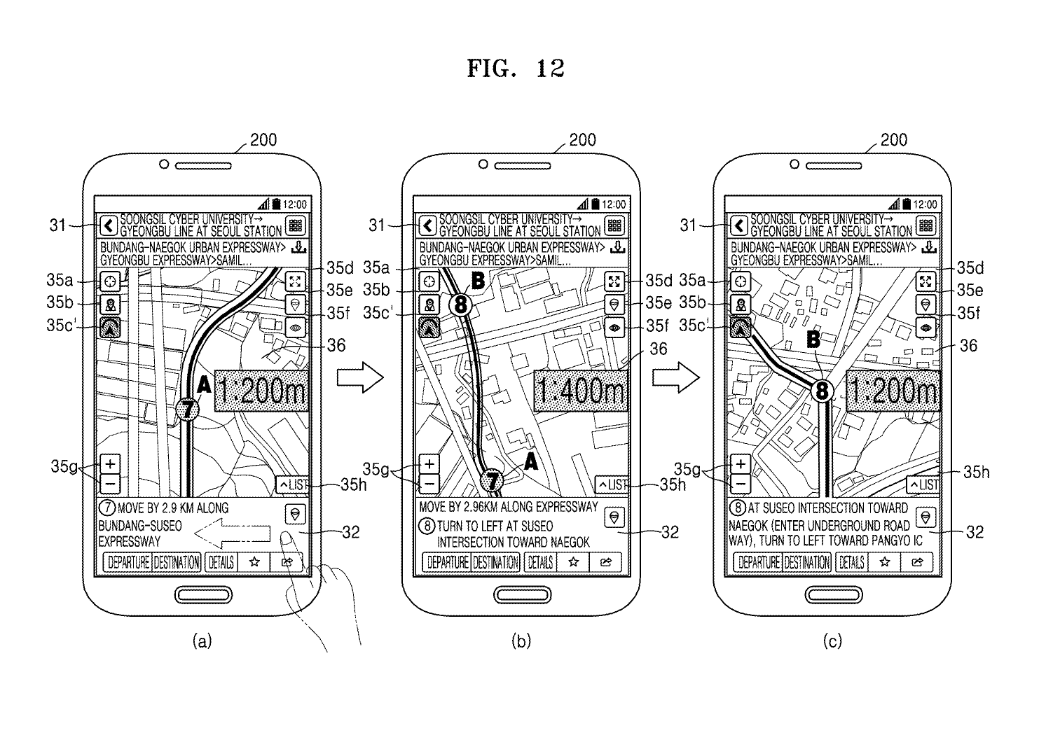

FIG. 12 is a diagram illustrating a case in which a direction and/or orientation of a map changes based on a route according to an example embodiment. FIG. 12 is a modified example of the embodiment of FIG. 11. Thus, parts of FIG. 12 that are the same or similar as those of FIG. 11 will not be described for the sake of brevity, and the example embodiment of FIG. 12 will be described herein focusing on distinguishing parts thereof. Referring to screens of FIGS. 12(a), (b) and (c), a rotation button 35c′ is ‘on’ and shaded. FIG. 12 is a diagram illustrating an embodiment to which a screen rotation function is applied.

The screen of FIG. 12(a) corresponds to the screen of FIG. 11(b). That is, the screen of FIG. 12(a) shows a case in which the single-location display unit 243 displays a map when a seventh junction is a selected location and/or position.

The screen of FIG. 12(b) shows a map obtained when the screen of FIG. 11(c) is rotated. A first point A and a second point B are displayed in the screen of FIG. 12(b) by the multi-location display unit 244, similar to the screen of FIG. 11(c). A north orientation of the map in the screen of FIG. 11(c) is in the same direction and/or orientation as the top of the screen, and a direction from the first point A to the second point B in the screen of FIG. 12(b) is in the same direction as the top of the screen. In other words, an orientation of the first point A relative to the second point B in the screen of FIG. 12(b) is the same orientation as the top of the screen. That is, since the direction of a route is the same as a direction from the seventh junction to the eighth junction, the map may be displayed such that a direction of movement of a user is in the same direction as the top of the screen, thereby providing an intuitive interface for the route.

According to an example embodiment, the animation unit 246 of FIG. 2 may apply an animation of rotating a map while the screen of FIG. 12(a) is switched to the screen of FIG. 12(b), so that a change in a direction of the map may be recognized by a user.

The screen of FIG. 12(c) shows an example embodiment of a map, the direction and/or orientation of which is the same as those of the screen of FIG. 12(b), which is displayed by the single-location display unit 243. That is, in the screen of FIG. 12(c), the eight junction is displayed at the center of the map in the third scale by the single-location display unit 243, similar to the screen of FIG. 11(d), but the direction and/or orientation of the screen of FIG. 12(c) is the same as that of the screen of FIG. 12(b).

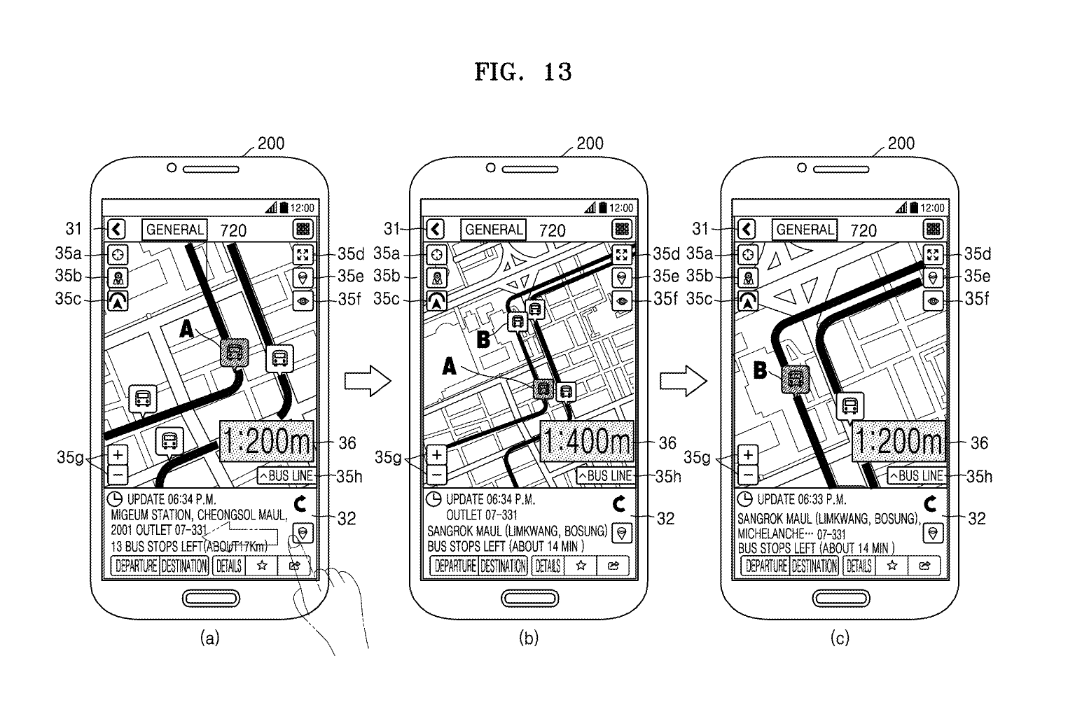

FIG. 13 illustrates a map displaying a transition state according to an example embodiment.

FIG. 13 is a diagram illustrating a result of applying a map of a transition state to a bus route search process according to an example embodiment. A public transportation route includes bus stops of a corresponding bus as junctions according to a bus line. Thus, a list of locations and/or positions is generated in the order of the locations and/or positions of the bus stops of the corresponding bus. FIG. 13 illustrates an example embodiment in which information regarding a route of a bus number 720 is provided.

A screen of FIG. 13(a) shows a case in which bus stops ‘Migeum station’, ‘Cheongsol maul’, and ‘2001 Outlet’ of the bus number 720 are selected locations and/or positions. In a map, bus stops which are first points A corresponding to the selected locations and/or positions are shaded. The single-location display unit 243 may display in a scale of 1:200 (which is a first scale) a map in which the first points A corresponding to ‘Migeum station’, ‘Cheongsol maul’, and ‘2001 Outlet’ are located at a center. In a state of the screen of FIG. 13(a), a user may perform a flick gesture the location information region 32 to designate ‘Sangrok maul (Limkwang, Bosung)’ which next bus stops as next selected locations and/or positions.

A screen of FIG. 13(b) is a screen displaying a transition state when the user designates the next selected locations and/or positions. The multi-location display unit 244 displays a map including both the first and second points A and B in a scale of 1:400 which is a second scale, as in the screen of FIG. 13(b). After the multi-location display unit 244 displays the screen of the transition state similar to the screen of FIG. 13(b) for a desired (or alternatively “predetermined”) time, the single-location display unit 243 may display second points B corresponding to ‘Sangrok maul (Limkwang, Bosung)’ at the center of the map as illustrated in FIG. 13(c).

A process of switching a screen displayed on the display unit of the user terminal 200 from the screen FIG. 13(a) to the screen of FIG. 13(b) and finally to the screen of FIG. 13 (c) may be controlled by the screen switch unit 245 and the animation unit 246 of FIG. 2 in a same or similar manner as discussed above with regards to FIGS. 9-12.

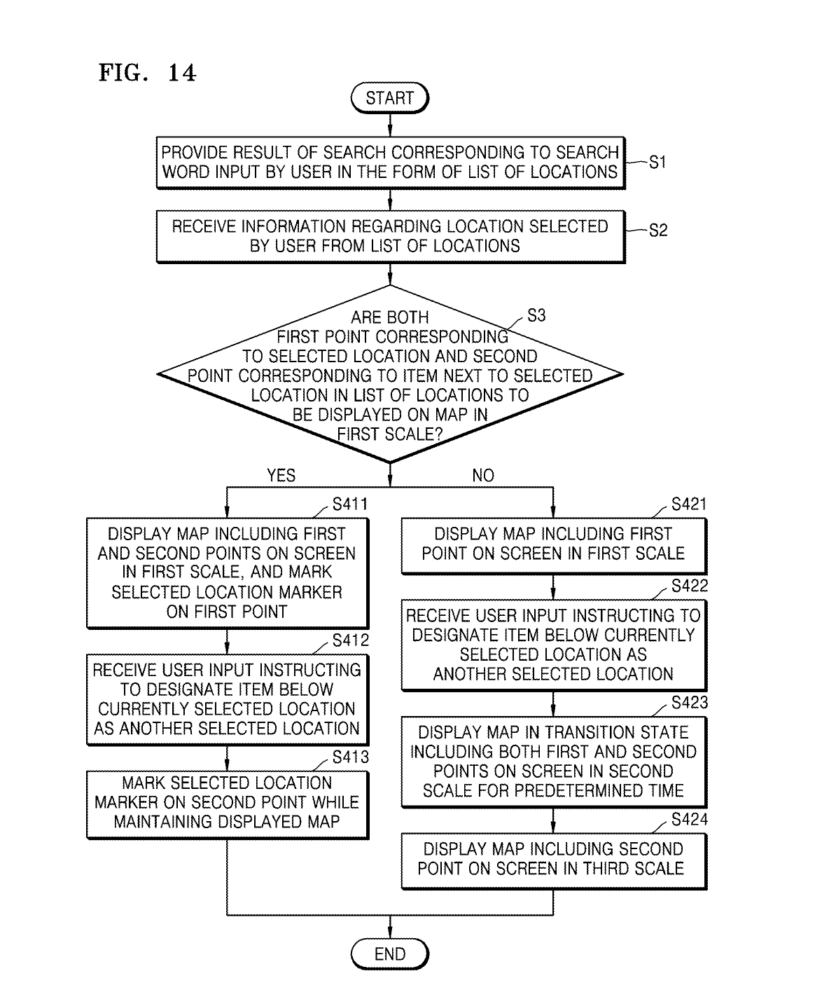

FIG. 14 is a flowchart of a method of providing a map transition interface according to an example embodiment.

In operation 51, the search result obtaining unit 22 provides a result of search corresponding to a search word input by a user in the form of a list of locations and/or positions. Then, in operation S2 the location selection unit 23 receives information regarding a location and/or position selected by the user from the list of locations and/or positions.

Then, in operation S3, the scale determination unit 241 and the scale comparison unit 242 determine whether both a first point corresponding to the selected location and/or position and a second point corresponding to an item next to the selected location and/or position in the list of locations are to be displayed on a map in a first scale. If at operation S3, the scale determination unit 241 and the scale comparison unit 242 determine that both the first and second points are to be displayed, the scale determination unit 241 and the scale comparison unit 242 proceed to operation S411 where the multi-location display unit 244 displays a map including the first point and the second point on a screen in the first scale and marks a selected location marker on the first point. If at operation S3, the scale determination unit 241 and the scale comparison unit 242 determine that both the first and second points are not to be displayed, then the scale determination unit 241 and the scale comparison unit 242 proceed to operation S421 where the screen switch unit 245 and the animation unit 246 provide a map transition interface of switching displaying of the screen.

Referring back to operation S411, the multi-location display unit 244 displays a map including the first point and the second point on a screen in the first scale and marks a selected location marker on the first point. Then at operation S412, the multi-location display unit 244 receives user input indicating to designate an item below the currently selected location and/or position as another selected location, and then in operation S413, the multi-location display unit 244 marks a selected location marker on the second point while maintaining the displayed map.

Referring back to operation S3, when the scale determination unit 241 and the scale comparison unit 242 determine in operation S3 that both the first and second points are not to be displayed, the screen switch unit 245 and the animation unit 246 provide a map transition interface of switching displaying of the screen. In various embodiments, at operation S421 the single-location display unit 243 displays a map including the first point on a screen in the first scale. Then, at operation S 422, a user input indicating to designate an item below the currently selected location as another selected location is received. Then, at operation S423 the multi-location display unit 244 displays a map in a transition state including both the first point and the second point on a screen in a second scale for a desired (or alternatively “predetermined”) time. Thereafter, at operation S424 the single-location display unit 243 displays a map including the second point on a screen in a third scale.

According to an example embodiment, the map transition interface described above is applicable to various cases in which a plurality of points, locations, and/or positions are displayed on a map. For example, the map transition interface described above is applicable to a case in which the second point is to be displayed while the first point is displayed on a screen, a case in which the second point returned as a result of search is to be displayed with the first point which is a current location, a case in which the first point and the second point selected by a user are to be displayed together, etc.

According to another example embodiment, the map transition interface described above may be applied conditionally. For example, the map transition interface described above may be used restrictively only when a scale for simultaneously displaying the first point and the second point is not within a desired (or alternatively “predetermined”) scale range. The desired (or alternatively “predetermined”) scale range may be a scale range that is desired (or alternatively “predetermined”) such that it is recognized and/or determined by a user. If the scale for simultaneously displaying the first point and the second point is not within the desired (or alternatively “predetermined”) scale range, a user may have difficulties recognizing and/or determining the map when only a screen displaying both the first point and the second point in the scale is displayed. In this case, the map transition interface may be used to help the user recognize and/or determine the map.

As described above, according to the one or more of the above example embodiments, when a search result corresponding to a search word is displayed, the search result may be displayed together with a current location of a user terminal 200 or a specific location and/or position. Thus, a user may detect the location and/or position of the search result relative to the current location and/or current position or the specific location and/or position. Therefore, a user's convenience may be increased according to the one or more of the above example embodiments.

According to the one or more of the above example embodiments, a transition state may be displayed during changing of a screen display state when a plurality of points are sequentially displayed on a map, thereby enabling a user to determine locations and/or position between the plurality of points. Accordingly, with the one or more of the above example embodiments, a user convenience may be increased.

With apparatuses and methods for providing a search service according to the one or more of the above embodiments, a search service may be provided to increase user convenience.

According to the one or more of the above embodiments, information regarding the location and/or position of a place corresponding to a search word is provided as a search result and information regarding a location and/or position of the search result with respect to a current location and/or current position is provided to increase user convenience.

The example embodiments as disclosed herein may comprise program code including program instructions, software components, software modules, data files, data structures, and/or the like that are implemented by one or more physical hardware devices. Examples of program code include both machine code produced by a compiler and higher level program code that is executed using an interpreter. The hardware devices include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

The hardware devices may also include one or more storage devices. The one or more storage devices may be computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the example embodiments as described above. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the example embodiments, or they may be known devices that are altered and/or modified for the purposes of the example embodiments.

It should be understood that the example embodiments described therein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. An apparatus for providing a search service, the apparatus comprising:
a processor including,
a search word obtaining unit configured to receive a search word, and
a search result obtaining unit configured to obtain a place search result corresponding to the search word, the place search result indicating a position associated with the search result; and
a display controller configured to display on a display device a map for displaying a first point corresponding to a desired position and a second point corresponding to the position indicated by the place search result, and
the display controller includes a scale determination unit configured to,
determine a scale of the map for displaying the first point and the second point on the map, and
simultaneously display the first point and the second point on the display device, and
the first point and the second point are displayed on the map according to the determined scale.

2. The apparatus of claim 1, wherein the first point indicates at least one or a current position of a user, a position selected by the user, and at least one position registered with a bookmark menu, and wherein
a first marker is used to indicate the first point on the map, and
a second marker is used to identify the second point on the map.

3. The apparatus of claim 2, wherein the processor further comprises:
a location selection unit configured to receive position-related information regarding at least one of the positions registered with the bookmark menu, and
the first point corresponds to the selected position.

4. The apparatus of claim 1, wherein
the search result obtaining unit is configured to obtain a plurality of search results corresponding to the search word, and the place search result is one of the plurality of search results that is most relevant to the search word from among the plurality of search results.

5. The apparatus of claim 1, wherein the scale determination unit is further configured to:
determine, as the scale of the map, a scale for displaying a region on a screen on the display device the region including a first diagonal vertex that corresponds to the first point and a second diagonal vertex that correspond to the second point, the region having a shape that corresponds to a shape of the display device.

6. The apparatus of claim 1, wherein a preset scale range includes preset upper limit and a preset lower limit.

7. The apparatus of claim 6, wherein the scale determination unit is further configured to:
determine a size of the display device and a resolution of the display device, and
set the preset scale range based on at least one of the size of the display device and the resolution of the display device.

8. The apparatus of claim 1, wherein the display controller further comprises:
a scale comparison unit configured to determine whether the determined scale is within a preset scale range,
when the scale comparison unit determines that the determined scale is within the preset scale range, the display controller is configured to display a map including the first point and the second point, and
when the scale comparison unit determines that the determined scale is not within the preset scale range, the display controller is configured to one of,
(i) display the map including the second point, and
(ii) sequentially provide a first screen displaying the map including the first point in a first scale, a second screen displaying the map including the first point and the second point in a second scale, and a third screen displaying the map including the second point in a third scale.

9. The apparatus of claim 8, wherein the display controller is configured to:
display a first animation of changing the map from the first scale to the second scale during a first transition from the first screen to the second screen when the first screen is displayed, and
display a second animation of changing the map from the second scale to the third scale during a second transition from the second screen to the third screen when the second screen is displayed.

10. The apparatus of claim 9, wherein the second scale is less than the first scale and the third scale, and
the first animation is a zoom-out animation, and the second animation is a zoom-in animation.

11. The apparatus of claim 8, wherein the display controller is configured to:
display on of the first point and the second point at a center of the map in the first screen and the third screen.

12. The apparatus of claim 8, wherein an orientation of the first point relative to the second point in the second screen is the same as an orientation of a top end of the second screen, and
the display controller is configured to display a rotation animation of rotating the map during a transition from the first screen to the second screen when the first screen is displayed.

13. The apparatus of claim 1, wherein
the search result obtaining unit is configured to,
obtain the search result from a service providing server in which a list of main places is registered,
obtain, from the service providing server, information associated with the search result indicating whether the search result corresponds to one of the listed main places and a desired scale for displaying the corresponding one of the listed main places, and
when the search result corresponds to the one of the listed the main places, the display controller is configured to display only the second point on a map using one of a basic scale or the desired scale.

14. The apparatus of claim 1, wherein the search result obtaining unit is configured to:
obtain information regarding a route corresponding to the search word, and
the first point and the second point are correspond to a first junction in the route and a second junction in the route, respectively.

15. The apparatus of claim 14, wherein the first point and the second point are at least one of consecutive junctions in the route and junctions selected by a user.

16. The apparatus of claim 1, wherein the display apparatus is configured to display a midpoint between the first point and the second point at a center of the map.

17. A method of providing a search service using a processor, the method comprising:
receiving, by the processor, a search word from an input device;
obtaining, by the processor, a place search result corresponding to the search word;
determining, by the processor, a scale of a map for simultaneously displaying a first point corresponding to a desired position and a second point corresponding to a position associated with the place search result; and
displaying, by the processor, the first point and the second point on a map having the determined scale.

18. The method of claim 17, further comprising:
determining whether the determined scale is within a preset scale range;
when the determined scale is determined to be within the preset scale range displaying a map including the first point and the second point; and
when the determined scale is determined to not be within the preset scale range one of,
(i) displaying the map including the second point, and
(ii) sequentially providing a first screen displaying the map including the first point in a first scale, a second screen displaying the map including the first point and the second point in a second scale, and a third screen displaying the map including the second point in a third scale.

19. The method of claim 18, further comprising:
displaying a first animation of changing the map from the first scale to the second scale during a first transition from the first screen to the second screen when the first screen is displayed; and
displaying a second animation of changing the map from the second scale to the third scale during a second transition from the second screen to the third screen when the second screen is displayed.

20. A method of providing a search service using a processor, the method comprising:
obtaining, by the processor, a plurality of place search results;
receiving, by the processor, information regarding a position associated with a selected place search result from the plurality of place search result;
determining, by the processor, whether a first point and a second point should be displayed on a map in a first scale, the first point corresponding to the selected position and the second point corresponding to one of the plurality of place search results that is closer the selected position than other ones of the plurality of search results;
when the determining determines that the first point and the second point should be displayed on the map in the first scale,
displaying, by the processor, a map including the first point and the second point on the map in the first scale; and
when the determining determines that the first point and the second point should not be displayed on the map in the first scale,
displaying, by the processor, the map including only the first point in the first scale,
displaying, by the processor, the map including the first point and the second point in a second scale, and
displaying, by the processor, the map including only the second point in a third scale.
